(19) United States
(12) Patent Application Publication
(10) Pub. No.: US 2026/0058547 A1
(43) Pub. Date: Feb. 26, 2026

(54) VERTICALLY STACKED POWER MODULE AND ASSOCIATED INDUCTOR ASSEMBLY

(71) Applicant: Monolithic Power Systems, Inc., Kirkland, WA (US)

(72) Inventors: Ting Ge, San Jose, CA (US); Daocheng Huang, San Jose, CA (US); Wenyang Huang, Hangzhou (CN); Zhe Yang, San Jose, CA (US); Yishi Su, Hangzhou (CN)

(21) Appl. No.: 18/811,329

(22) Filed: Aug. 21, 2024

(51) Int. Cl. H02M 3/00; H01F 27/06; H01F 27/24; H01F 27/28; H02M 3/158

(52) U.S. Cl. CPC H02M 3/003; H01F 27/06; H01F 27/24; H01F 27/28; H02M 3/158

(57) ABSTRACT

A power module has an inductor assembly and a device substrate. The inductor assembly has a magnetic core, a first winding and a second winding. Each of the first winding and the second winding comprises a first portion, a second portion, a third portion and a fourth portion. The third portion connects the first portion end the second portion, the fourth portion is connected to the second portion. The device substrate has a first power device chip and a second power device chip. A first end of the first winding is electrically connected to the first power device chip, a second end of the first winding is electrically connected to a first output voltage terminal. A first end of the second winding is electrically connected to a second output voltage terminal, and a second end of the second winding is electrically connected to the second power device chip.

### BACKGROUND OF THE INVENTION

### 1. Field of the Invention

The present invention relates generally to electronic components, and more particularly but not exclusively to vertically stacked power modules and associated inductor assemblies.

### 2. Description of Related Art

Power converter, as known in the art, converts an input power to an output power for providing a load with required voltage and current. Multi-phase power converter comprising a plurality of paralleled power stages operating out of phase has lower output ripple voltage, better transient performance and lower ripple-current-rating requirements for input capacitors. They are widely used in high current and low voltage applications, such as server, microprocessor.

With the development of modern GPUs (Graphics Processing Units), and CPUs (Central Processing Units), increasingly high load current is required to achieve better processor performance. Besides, to improve integration density of the terminal products like CPUs and GPUs, the size of their power converters needs to be smaller. Higher current and smaller size put more challenges to the heat conduction of the power converters. Therefore, high-power density and high-efficiency power modules with excellent heat dissipation path are necessary for the processers.

### SUMMARY OF THE INVENTION

It is one of the objects of the present invention to provide a power module with excellent thermal efficiency and high integrity.

One embodiment of the present invention discloses a power module. The power module comprises an inductor assembly and a device substrate below the inductor assembly. The inductor assembly has a first surface and a second surface opposite to each other. The inductor assembly comprises a magnetic core, a first winding and a second winding at least partially embedded within the magnetic core. Each of the first winding and the second winding comprises a first portion, a second portion, a third portion and a fourth portion. The second portion comprises a top surface exposed at the first surface of the inductor assembly. The third portion connects the first portion and the second portion, and is perpendicular to the first surface and the second surface of the inductor assembly. The fourth portion is connected to the second portion. The device substrate has a first surface and a second surface opposite to each other, and comprises a first power device chip and a second power device chip. The first power device chip and the second power device chip are embedded in the device substrate. The first winding has a first end and a second end, the first end of the first winding is electrically connected to the first power device chip, and the second end of the first winding is electrically connected to a first output voltage terminal. The second winding has a first end and a second end, the first end of the second winding is electrically connected to a second output voltage terminal, and the second end of the second winding is electrically connected to the second power device chip.

Another embodiment of the present invention discloses a power module. The power module comprises an inductor assembly and a device substrate below the inductor assembly. The inductor assembly has a first surface and a second surface opposite to each other. The inductor assembly comprises a magnetic core, a first winding and a second winding at least partially embedded within the magnetic core and a secondary winding interposed between the first winding and the second winding. Each of the first winding and the second winding has a first end exposed at the second surface of the inductor assembly and a second end exposed at the second surface of the inductor assembly. The magnetic core passes through the secondary winding. The secondary winding comprises a first end and a second end exposed at the second surface of the inductor assembly. The device substrate has a first surface and a second surface opposite to each other, and comprises a first power device chip, a second power device chip, a first trans-inductor connector and a second trans-inductor connector. The first power device chip and the second power device chip are embedded in the device substrate. The first end of the first winding is electrically connected to a first output voltage terminal, and the second end of the first winding is electrically connected to the first power device chip. The first end of the second winding is electrically connected to a second output voltage terminal, and the second end of the second winding is electrically connected to the second power device chip. The first end of the secondary winding is electrically connected to the first trans-inductor connector, and the second end of the secondary winding is electrically connected to the second trans-inductor connector.

Yet another embodiment of the present invention discloses an inductor assembly for a power module, the inductor assembly comprises a first surface and a second surface opposite to each other, a magnetic core, a first winding and a second winding at least partially embedded within the magnetic core and a secondary winding interposed between the first winding, and the second winding. Each of the first winding and the second winding comprises a first portion, a second portion comprising a top surface exposed at the first surface of the inductor assembly, a third portion connecting the first portion and the second portion, the third portion is perpendicular to the first surface and the second surface of the inductor assembly, and a fourth portion connected to the second portion. The secondary winding is at least partially embedded within the magnetic core, the secondary winding comprises a first end and a second end exposed at the second surface of the inductor assembly. The first winding has a first end and a second end, the first end of the first winding is electrically connected to a first pad to receive a first input signal, the second end of the first winding is electrically connected to a second pad to provide a first output signal. The second winding has a first end and a second end, the second end of the second winding is electrically connected to a third pad to receive a second input signal, the first end of the second winding is electrically connected to a fourth pad to provide a second output signal. The first end of the secondary winding is electrically connected to a fifth pad, the second end of the secondary winding is electrically connected to a sixth pad.

Yet another embodiment of the present invention discloses an inductor assembly for a power module. The inductor assembly comprises a first surface and a second surface opposite to each other, a magnetic core, a first winding and a second winding at least partially embedded within the magnetic core. Each of the first winding and the second winding comprises a first portion, a second portion comprising a top surface exposed at the first surface of the inductor assembly, a third portion connecting the first portion and the second portion, the third portion is perpendicular to the first surface and the second surface of the inductor assembly, and a fourth portion connected to the second portion. The first winding has a first end and a second end, the first end of the first winding is electrically connected to a first pad to receive a first input signal, the second end of the first winding is electrically connected to a second pad to provide a first output signal. The second winding has a first end and a second end, the second end of the second winding is electrically connected to a third pad to receive a second input signal, the first end of the second winding is electrically connected to a fourth pad to provide a second output signal.

These and other features of the present invention will be readily apparent to persons of ordinary skill in the art upon reading the entirety of this disclosure, which comprises the accompanying drawings and claims.

### BRIEF DESCRIPTION OF DRAWINGS

The present invention can be further understood with reference to the following detailed description and the appended drawings, wherein like elements are provided with like reference numerals.

FIG. 1 schematically shows a prior art multi-phase power converter 10.

FIG. 2 shows a power module 20 for a dual-phase power converter in accordance with an embodiment of the present invention.

FIG. 3 shows a disassembled and perspective view illustrating the power module 20 of FIG. 2.

FIG. 4 shows a perspective view of a first winding 203-1 and second winding 203-2 in accordance with an embodiment of the present invention.

FIG. 5 shows a bottom view of an inductor assembly 203 in accordance with an embodiment of the present invention.

FIG. 6 shows a top view of a device substrate 202 in accordance with an embodiment of the present invention.

FIG. 7 shows a bottom view of the device substrate 202 in accordance with an embodiment of the present invention.

FIG. 8 shows a bottom view of a bottom substrate 201 in accordance with an embodiment of the present invention.

FIG. 9A shows a cross-sectional view illustrating the power module 20 taken along line AA′ of FIG. 2 in accordance with an embodiment of the present invention.

FIG. 9B shows a cross-sectional view illustrating the power module 20 taken along line BB′ of FIG. 2 in accordance with an embodiment of the present invention.

FIG. 10 shows a power module 30 for a dual-phase power converter in accordance with another embodiment of the present invention.

FIG. 11 shows a disassembled and perspective view illustrating the power module 30 of FIG. 10.

FIG. 12 shows a perspective view of a first winding 303-1 and second winding 303-2 in accordance with an embodiment of the present invention.

FIG. 13 shows a bottom view of an inductor assembly 303 in accordance with an embodiment of the present invention.

FIG. 14 shows a top view of a device substrate 302 in accordance with an embodiment of the present invention.

FIG. 15A shows a cross-sectional view illustrating the power module 30 taken along line CC′ of FIG. 10 in accordance with an embodiment of the present invention.

FIG. 15B shows a cross-sectional view illustrating the power module 30 taken along line DD′ of FIG. 10 in accordance with an embodiment of the present invention.

FIG. 15C shows a cross-sectional view illustrating the power module 30 taken along line EE′ of FIG. 10 in accordance with an embodiment of the present invention.

FIG. 16 shows a disassembled and perspective view illustrating a power module 200 for a dual-phase power converter in accordance with another embodiment of the present invention.

FIG. 17 shows a disassembled and perspective view illustrating a power module 300 for a dual-phase power converter in accordance with another embodiment of the present invention.

FIG. 18 shows a perspective view of a first winding 3003-1 and second winding 3003-2 in accordance with an embodiment of the present invention.

FIG. 19 schematically shows a multi-phase trans-inductor voltage regulator (TLVR) 40 in accordance with an embodiment of the present invention.

FIG. 20 schematically shows a power module 50 for a dual-phase TLVR in accordance with an embodiment of the present invention.

FIG. 21 shows a disassembled and perspective view illustrating the power module 50 of FIG. 13.

FIG. 22 shows a perspective view of a first winding 503-1, second winding 503-2 and the seondary winding 503-6 in accordance with an embodiment of the present invention.

FIG. 23 shows a bottom view of an inductor assembly 503 in accordance with an embodiment of the present invention.

FIG. 24 shows a top view of the device substrate 502 in accordance with an embodiment of the present invention.

FIG. 25 shows a bottom view of the device substrate 502 in accordance with an embodiment of the present invention.

FIG. 26 shows a bottom view of a bottom substrate 501 in accordance with an embodiment of the present invention.

FIG. 27A shows a cross-sectional view illustrating the power module 50 taken along line AA′ of FIG. 20 in accordance with an embodiment of the present invention.

FIG. 27B shows a cross-sectional view illustrating the power module 50 taken along line BB′ of FIG. 20 in accordance with an embodiment of the present invention.

FIG. 27C shows a cross-sectional view illustrating the power module 50 taken along line CC′ of FIG. 20 in accordance with an embodiment of the present invention.

FIG. 28 schematically shows a power module 60 for a dual-phase TLVR in accordance with an embodiment of the present invention.

FIG. 29 shows a disassembled and perspective view illustrating the power module 60 of FIG. 28.

FIG. 30 shows a perspective view of a first winding 603-1, second winding 603-2 and the seondary winding 603-6 in accordance with an embodiment of the present invention.

FIG. 31A shows a cross-sectional view illustrating the power module 60 taken along line DD′ of FIG. 28 in accordance with an embodiment of the present invention.

FIG. 31B shows a cross-sectional view illustrating the power module 60 taken along line EE′ of FIG. 28 in accordance with an embodiment of the present invention.

FIG. 31C shows a cross-sectional view illustrating the power module 60 taken along line FF′ of FIG. 28 in accordance with an embodiment of the present invention.

FIG. 32 shows a disassembled and perspective view illustrating a power module 500 for a dual-phase TLVR in accordance with an embodiment of the present invention.

FIG. 33 shows a disassembled and perspective view illustrating a power module 600 for a dual-phase TLVR in accordance with an embodiment of the present invention.

### DETAILED DESCRIPTION OF THE INVENTION

In the present disclosure, numerous specific details are provided, such as examples of electrical circuits and components, to provide a thorough understanding of embodiments of the invention. Persons of ordinary skill in the art will recognize, however, that the invention can be practiced without one or more of the specific details. It is noted that, for purposes of illustrative clarity, certain elements in the drawings may not be drawn to scale. In other instances, well-known details are not shown or described to avoid obscuring aspects of the invention.

Throughout the specification and claims, the terms “left”, “right”, “in”, “out”, “front”, “back”, “up”, “down”, “top”, “atop”, “bottom”, “on”, “over”, “under”, “above”, “below”, “vertical” and the like, if any, are used for descriptive purposes and not necessarily for describing permanent relative positions. It is to be understood that the terms so used are interchangeable under appropriate circumstances such that embodiments of the technology described herein are, for example, capable of operation in other orientations than those illustrated or otherwise described herein. The phrases “in one embodiment”, “in some embodiments”, “in one implementation”, and “in some implementations” as used includes both combinations and sub-combinations of various features described herein as well as variations and modifications thereof. These phrases used herein does not necessarily refer to the same embodiment, although it may. Those skilled in the art should understand that the meanings of the terms identified above do not necessarily limit the terms, but merely provide illustrative examples for the terms. It is noted that when an element is “connected to” or “coupled to” the other element, it means that the element is directly connected to or coupled to the other element, or indirectly connected to or coupled to the other element via another element. Particular features, structures or characteristics may be included in an integrated circuit, an electronic circuit, a combinational logic circuit, or other suitable components that provide the described functionality. In addition, it is appreciated that the figures provided herewith are for explanation purposes to persons ordinarily skilled in the art and that the drawings are not necessarily drawn to scale.

Embodiments of the present invention relate to power converters with inversely coupled inductors, and some power converters having trans-inductor structure in addition thereto. Such designs allow changes in load current to affect each phase of the circuit, resulting in faster transient response compared to other voltage regulator topologies.

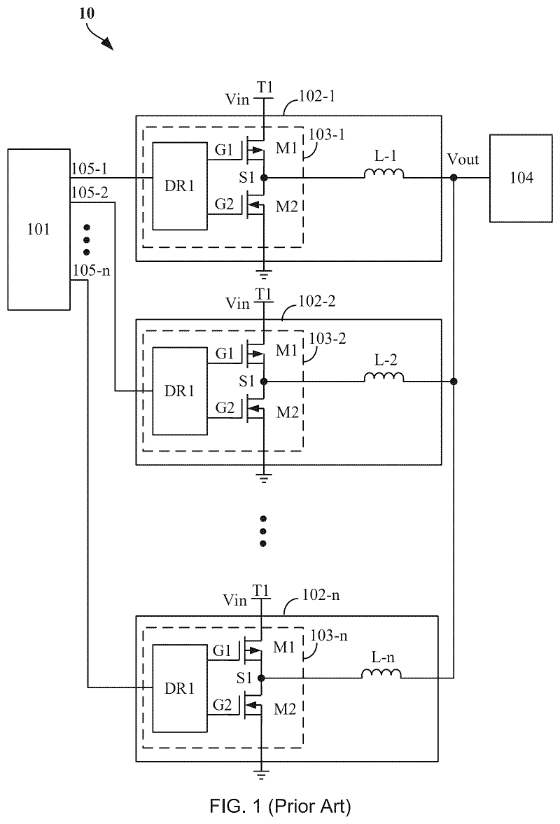

FIG. 1 schematically shows a prior art multi-phase power converter 10. The prior art multi-phase power converter 10 comprises a controller 101, power blocks 103-1˜103-n and inductors L-1˜L-n for supplying power to a load 104, wherein n is an integer, and n≥1. Each power block 103 and one inductor L represent one power stage, i.e., one phase 102 of the power converter 10, as shown in FIG. 1. Each power block 103 includes switches M1, M2 and a driver DR1 for providing driving signals G1 and G2 to drive the switches M1 and M2 respectively. The controller 101 provides n switching control signals 105-1˜105-n respectively to n power blocks 103-1˜103-n to control n phases 102-1˜102-n working out of phase, i.e., each one of the inductors L-1˜L-n sequentially absorbs power from an input source (e.g., absorbs an input voltage Vin) and sequentially delivers power to the load 104 (e.g., delivers output voltage Vout). It should be noticed that outputs of all phases as shown in FIG. 1 are connected to work as a multi-phase power converter. However, each phase output may be separated to work as multiple independent converters which could have different output voltage levels for different load demands.

The power stage 102 with Buck topology is shown in FIG. 1 for example. Persons of ordinary skill in the art should appreciate that power stages with other topologies, like Boost topology, Buck-Boost topology could also be adopted in the multi-phase power converter.

The inductors L-1˜L-n could be implemented by one or a few coupled inductors or could be implemented by n single inductors.

When n=2, the multi-phase power converter 10 is used as a dual-phase power converter or two separate single-phase converters. For the ease of description, a dual-phase power module for the dual-phase power converter is discussed as an example to illustrate the present invention.

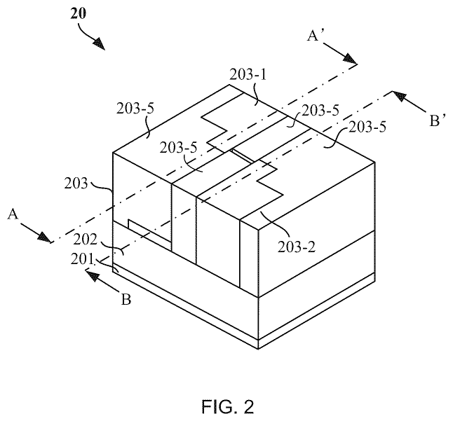

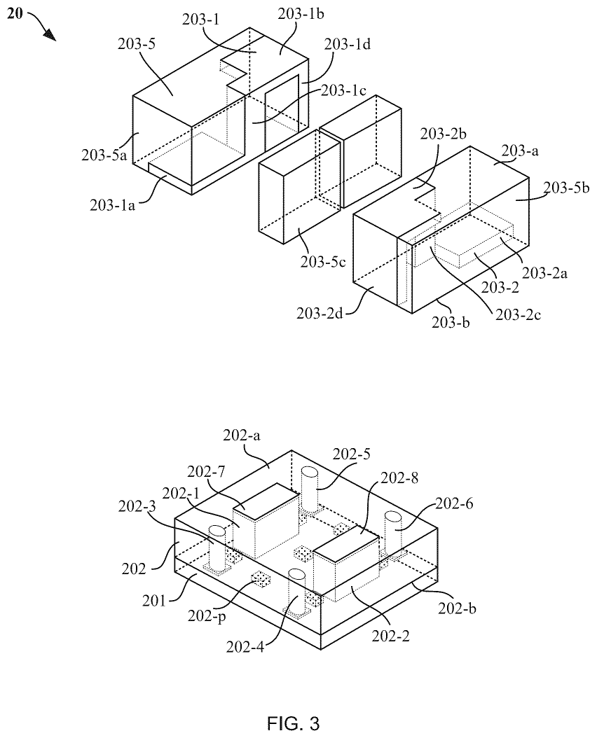

FIG. 2 shows a power module 20 for a dual-phase power converter in accordance with an embodiment of the present invention. The power module 20 may serve as the power stage 102 of FIG. 1, with n=2. The power module 20 includes a bottom substrate 201, a device substrate 202 and an inductor assembly 203. The bottom substrate 201 is arranged at the bottom of the power module 20, the device substrate 202 is arranged on the bottom substrate 201, and the inductor assembly 203 is arranged on the device substrate 202. The inductor assembly 203 comprises a first winding 203-1, a second winding 203-2 and a magnetic core 203-5. The first winding 203-1 and the magnetic core 203-5 form the first inductor L-1 as shown in FIG. 1. The second winding 203-2 and the magnetic core 203-5 form the second inductor L-2 as shown in FIG. 1. Thus, the inductors (e.g., L-1 and L-2 in FIG. 1) are integrated in the inductor assembly 203. In one embodiment, the magnetic core 203-5 may comprise a plurality of portions as shown in FIG. 3. However, one with ordinary skill in the art should also understand that the magnetic core 203-5 may be a single unit. The first winding 203-1 and the second winding 203-2 are embedded in the magnetic core 203-5 of the inductor assembly 203, and the first winding 203-1 and the second winding 203-2 are at least partially exposed on the surface of the magnetic core 203-5. Moreover, the first winding 203-1 and second winding 203-2 also work as heat sinks, so that additional heat sink layers could be omitted in the power module 20. As shown in FIG. 3, the magnetic core 203-5 may comprise a plurality of portions, and each portion may include the same or different materials. However, in the other embodiment, the magnetic core may be a single unit made of single material.

FIG. 3 shows a disassembled and perspective view illustrating the power module 20 of FIG. 2. As shown in FIG. 2, the power module 20 includes the bottom substrate 201, the device substrate 202 and the inductor assembly 203. The device substrate 202 and the inductor assembly 203 of the power module 20 will be described below in detail according to FIG. 3. The bottom substrate 201 below the device substrate 202 has a first surface 201-a and a second surface 201-b opposite to the first surface 202-a. The first surface 201-a of the bottom substrate 201 faces the device substrate. The device substrate 202 below the inductor assembly 203 has a first surface 202-a and a second surface 202-b opposite to the first surface 202-a, and the device substrate 202 comprises a first power device chip 202-1, a second power device chip 202-2, a top heat layer 202-7 at least partially covering the first power device chip 202-1, a top heat layer 202-8 at least partially covering the second power device chip 202-2, a connector 202-3, a connector 202-4, a connector 202-5, a connector 202-6, and a plurality of discrete components 202-p. Herein, all these components of the device substrate 202 are at least partially embedded within the device substrate 202. Moreover, in an embodiment of the present invention, the connector can be a connecting pillar or the other connecting elements have different shapes.

As shown in FIG. 3, in the device substrate 202, each of the first power device chip 202-1 and the second power device chip 202-2 integrates one power block 103 in FIG. 1, which includes the switches M1, M2, the driver DR1, and further integrates some auxiliary circuits not shown in FIG. 1. Each of the top heat layers 202-7 and 202-8 has a surface exposed at the first surface 202-a of the device substrate 202. The connector 202-3 and the connector 202-5 are arranged at opposite sides of the first power device chip 202-1. The connector 202-4 and the connector 202-6 are arranged at opposite sides of the second power device chip 202-2. Each of the connectors 202-3, 202-4, 202-5, and 202-6 has a first end exposed at the first surface 202-a of the device substrate 202 and a second end electrically connected to at least one terminal of the second surface 202-b of the device substrate 202. The first end electrically connected to the corresponding winding of the inductor assembly 203, and the second end electrically connected to the bottom substrate 201 via the at least one terminal of the second surface 202-b of the device substrate 202. The connectors shown in the example of FIG. 3 are cylinders. It should be appreciated that any shape of the connectors is applicable to the present invention. The discrete components 202-p includes resistors and capacitors of the power converter 10, like input capacitors at an input terminal T1 of the power converter 10 for receiving the input voltage Vin to provide pulse current, the capacitors and resistors for the drivers DR1 and internal logic circuits power supplies (not shown in FIG. 1), etc.

As shown in FIG. 3, the inductor assembly 203 is disposed above the device substrate 202, and comprises the magnetic core 203-5, the first winding 203-1, and the second winding 203-2. The magnetic core 203-5 comprises a first magnetic core portion 203-5a, a second magnetic core portion 203-5b, and a third magnetic core portion 203-5c. The first winding 203-1 has a first portion 203-1a, a second portion 203-1b, a third portion 203-1c connecting the first portion 203-1a and the second portion 203-1b, and a fourth portion 203-1d connected to the second portion 203-1b. The second winding 203-2 has a first portion 203-2a, a second portion 203-2b, a third portion 203-2c connecting the first portion 203-2a and the second portion 203-2b, and a fourth portion 203-2d connected to the second portion 203-2b. In an example of FIG. 3, the inductor assembly 203 is disassembled into three portions corresponding to the three magnetic core portions 203-5a to 203-5c for ease of understanding. The inductor assembly 203 has a first surface 203-a and a second surface 203-b, the first surface 203-a and the second surface 203-b are opposite to each other. The first winding 203-1 is at least partially embedded in the first magnetic core portion 203-5a, the second winding 203-2 is at least partially embedded in the second magnetic core portion 203-5c, and the third magnetic core portion 203-5c is disposed between the first magnetic core portion 203-5a and the second magnetic core portion 203-5b. As shown in FIG. 3, the third magnetic core portion 203-5c separates the first winding 203-1 and the second winding 203-2. Moreover, the third magnetic core portion 203-5c comprises two separate ferrite blocks and an air gap in between. In one embodiment, the third core portion 203-5b may also be a bulk made of the other materials (e.g., iron powder) containing or not containing the air gap. The first magnetic core portion 203-5a, the second magnetic core portion 203-5b, and the third magnetic core portion 203-5c may include the same materials, or at least two of the first magnetic core portion 203-5a, the second magnetic core portion203-5b, and the third magnetic core portion 203-5c may comprise different materials. For example, at least one core portion (at least one of the 203-5a to 203-5c) may be made of a magnetic material having a high permeability, like ferrite material, which includes MnZn, NiZn, etc., and/or at least one core portion (at least one of the 203-5a to 203-5c) may be made of a magnetic material having a relatively low permeability, like powder iron material, which includes FeSiAl, FeSi, FeNi, etc. Persons of ordinary skill in the art should appreciate that magnetic cores having other structures and/or materials are also suitable for the power module of the embodiments of the present invention.

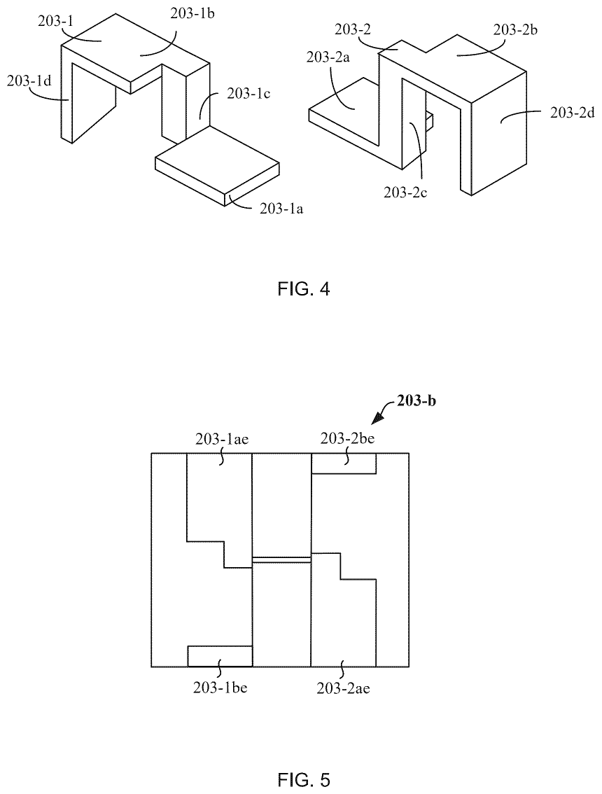

FIG. 4 shows a perspective view of a first winding 203-1 and second winding 203-2 in accordance with an embodiment of the present invention. In one embodiment of the present invention, the first winding 203-1 comprises a first end 203-1ae and a second end 203-1be exposed at the second surface 203-b of the inductor assembly 203 (see FIG. 5). As previously described in FIG. 3, the first winding 203-1 has the first portion 203-1a, the second portion 203-1b, the third portion 203-1c and the fourth portion 203-1d. The second portion 203-1b comprises a top surface exposed at the first surface 203-a of the inductor assembly 203, the third portion 203-1c is perpendicular to the first surface 203-a and the second surface 203-b of the inductor assembly 203, and the fourth portion 203-1d is perpendicular to the first surface 203-a and the second surface 203-b of the inductor assembly 203 as well.

Similarly, the second winding 203-2 comprises a first end 203-2ae and a second end 203-2be exposed at the second surface 203-b of the inductor assembly 203 (see FIG. 5). As previously described in FIG. 3, the second winding 203-2 has the first portion 203-2a, the second portion 203-2b, the third portion 203-2c and the fourth portion 203-2d. The second portion 203-2b comprises a top surface exposed at the first surface 203-a of the inductor assembly 203, the third portion 203-2c is perpendicular to the first surface 203-a and the second surface 203-b of the inductor assembly 203, and the fourth portion 203-2d is perpendicular to the first surface 203-a and the second surface 203-b of the inductor assembly 203 as well.

Moreover, each of the second portion 203-1b and 203-2b is parallel to the second surface 203-b of the inductor assembly and each of the fourth portion 203-1d and 203-2d is perpendicular to the second surface 203-b of the inductor assembly.

As shown in FIG. 3 and FIG. 4, the first portion 203-1a of the first winding 203-1 and the second portion 203-2b of the second winding 203-2 are facing the same direction, the second portion 203-1b of the first winding 203-1 and the first portion 203-2a of the second winding 203-2 are facing the same direction, in the first winding 203-1 and the second winding 203-2, the first portions 203-1a, 203-2a and the second portions 203-1b, 203-2b are facing the opposite direction. The third portion 203-1c of the first winding 203-1 and the third portion 203-2c of the second winding 203-2 are parallel to each other.

In some embodiments, the first winding 203-1 and the second winding 203-2 further have some parts exposed at other surfaces of the inductor assembly, and the first winding 203-1 and the second winding 203-2 are made of copper.

As can be seen from FIG. 3 and FIG. 4, when the bottom substrate 201, the device substrate 202 and the inductor assembly 203 are assembled together, the second surface 202-b of the device substrate 202 faces the first surface of the bottom substrate 201, and the second surface 203-b of the inductor assembly 203 faces the first surface 202-a of the device substrate 202. The first winding 203-1 and the second winding 203-2 are electrically connected to the bottom substrate 201 via the device substrate 202. The first end 203-1ae of the first winding 203-1 is electrically connected to the connector 202-3 and the top heat layer 202-7, and the second end 203-1be of the first winding 203-1 is electrically connected to the connector 202-5. Similarly, the first end 203-2ae of the second winding 203-2 is electrically connected to the connector 202-4 and the top heat layer 202-8, and the second end 203-2be of the second winding 203-2 is electrically connected to the connector 202-6.

FIG. 5 shows a bottom view of the inductor assembly 203 in accordance with an embodiment of the present invention.

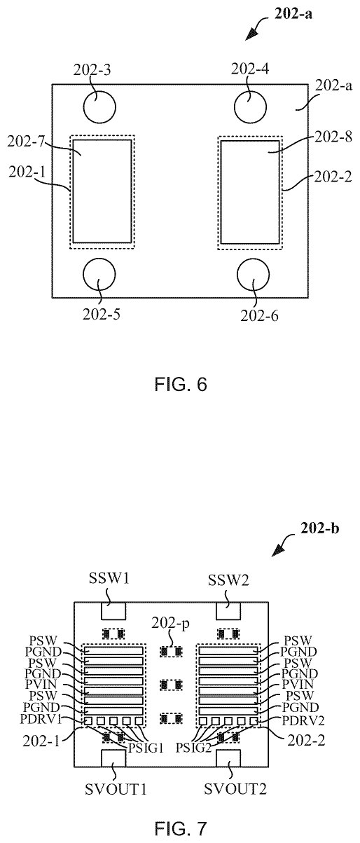

FIG. 6 shows a top view of the device substrate 202 in accordance with an embodiment of the present invention.

As shown in FIG. 5 and FIG. 6, the first end 203-1ae of the first winding 203-1 is exposed at the second surface 203-b of the inductor assembly 203, and is electrically connected to a first end of the connector 202-3 and the top heat layer 202-7. The second end 203-1be of the first winding 203-1 is exposed at the second surface 203-b of the inductor assembly 203, and is electrically connected to the first end of the connector 202-5. Similarly, the first end 203-2ae of the second winding 203-2 is exposed at the second surface 203-b of the inductor assembly 203, and is electrically connected to the first end of the connector 202-6 and the top heat layer 202-8. The second end 203-2be of the second winding 203-2 is exposed at the second surface 203-b of the inductor assembly 203, and is electrically connected to the first end of the connector 202-4. In one embodiment, the first end 203-1ae and the second end 203-1be of the first winding 203-1 are physically attached to the first end of the connector 202-3 and the first end of the connector 202-5 respectively by soldering or via a conductive adhesive, and the first end 203-2ae and the second end 203-2be of the second winding 203-2 are physically attached to the first end of the connector 202-4 and the first end of the connector 202-6 by soldering or via a conductive adhesive.

Furthermore, in the example of FIG. 5 and FIG. 6, the first end 203-1ae of the first winding 203-1, and the connector 202-3, are electrically connected to the first power device chip 202-1 via conductive traces inside the bottom substrate 201. Consequently, the heat of the first power device chip 202-1 is further dissipated through the connector 202-3 and the first winding 203-1. In the example of FIG. 5 and FIG. 6, the first end 203-2ae of the second winding 203-2, and the connector 202-6, are electrically connected to the second power device chip 202-2 via conductive traces inside the bottom substrate 201. Consequently, the heat of the second power device chip 202-2 is further dissipated through the connector 202-6 and the second winding 203-2.

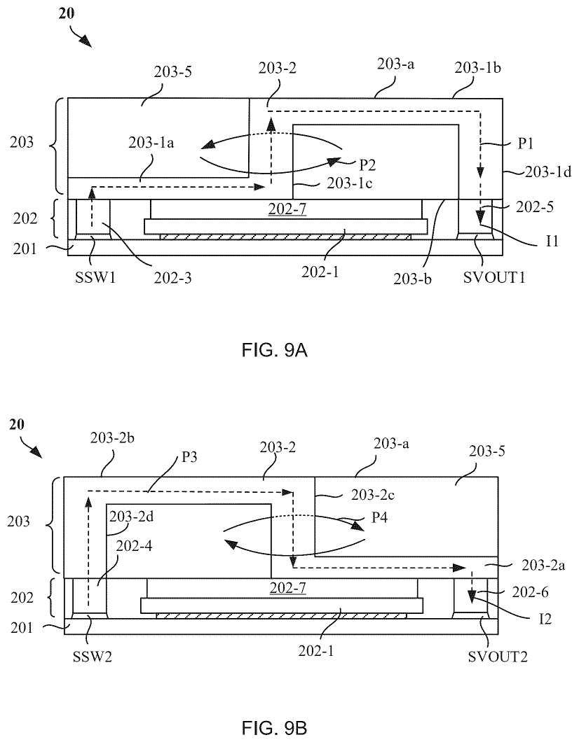

In one embodiment, the first end 203-1ae of the first winding 203-1 is electrically connected to an external pad via the connector 202-3 to receive a first input signal, the second end 203-1be of the first winding 203-1 is electrically connected to an external pad via the connector 202-5 to provide a first output signal. The first input signal may represent the input voltage (Vin in FIG. 1), the first output signal may represent the output voltage (Vout in FIG. 1). The second end 203-2be of the second winding 203-2 is electrically connected to an external pad via the connector 202-4 to receive a second input signal, the first end 203-2ae of the second winding 203-2 is electrically connected to an external pad via the connector 202-6 to provide a second output signal. The second input signal may represent the input voltage (Vin in FIG. 1), the second output signal may represent the output voltage (Vout in FIG. 1). In this electrical connection structure, the currents flowing through the third portion 203-1c of the first winding 203-1 and the third portion 203-2c of the second winding 203-2 could have opposite current directions, thus induce an inverse coupling between the two inductors (e.g. L-1 and L-2 in FIG. 1) formed by the first winding 203-1, the second winding 203-2 and the magnetic core 203-5, which will be further illustrated in with FIG. 9.

FIG. 7 shows a bottom view of the device substrate 202, i.e., the second surface 202-b of the device substrate 202 in accordance with an embodiment of the present invention. As mentioned before, each of the first power device chip 202-1 and the second power device chip 202-2 integrates the switches M1, M2, the driver DR1 shown in FIG. 1 and other accessory circuits. Therefore, each of the first power device chip 202-1 and the second power device chip 202-2 has a plurality of pins including at least an input pin PVIN, at least one switching pin PSW, at least one ground pin PGND, and a driving pin PDRV1 as shown in FIG. 7 (not all of the switching pins PSW and ground pins PGND are labeled in FIG. 7 for clarity of illustration). Taking the first power device chip 202-1 as an example, a common node of the switches M1 and M2 is connected to the at least one switching pin PSW. To be specific, the first switch M1 has a first terminal coupled to the input pin PVIN (corresponding to the input terminal T1 in FIG. 1) to receive the input voltage Vin (shown in FIG. 1), a second terminal coupled to the at least one switching pin PSW (corresponding to the switching terminal S1 in FIG. 1), and a control terminal configured to receive a first driving signal G1. The second switch M2 has a first terminal coupled to the at least one switching pin PSW, a second terminal coupled to the ground pin PGND, and a control terminal configured to receive a second driving signal G2. The driving pin PDRV1 is electrically connected to at least two pads of the signal pad area TSIG. The driver DR1 is coupled to the driving pin PDRV1 to receive a switching control signal 105 shown in FIG. 1, and to provide the first driving signal G1 and the second driving signal G2 based on the switching control signal 105. The plurality of pins of the first power device chip 202-1 and the second power device chip 202-2 are electrically connected to external circuits/devices/components via the bottom substrate 201. The bottom substrate 201 may be attached to a mainboard where the load (CPU, GPU, etc.) are located, and there may be circuits/devices/components on the mainboard providing the input voltage Vin, the switching control signal 105, and a ground reference that provides a common ground for the first power device chip 202-1 and the second power device chip 202-2 via the ground pins PGND.

In the example of FIG. 7, a second end of the connector 202-3 is electrically connected to the bottom substrate 201 below the device substrate 202 via a first switching terminal SSW1. Furthermore, the second end of the connector 202-3 is electrically connected to the at least one switching pin PSW of the first power device chip 202-1 via conductive traces inside the bottom substrate 201. That is, the first end 203-1ae of the first winding 203-1 is electrically connected to the switching pin PSW of the first power device chip 202-1 via the connector 202-3. The second end of the connector 202-5 is electrically connected to the bottom substrate 201 via a first output voltage terminal SVOUT1. So, the second end 203-1be of the first winding 203-1 is electrically connected to the first output voltage terminal SVOUT1 via the connector 202-5. The second end of the connector 202-4 is electrically connected to the bottom substrate 201 via a second switching terminal SSW2. Furthermore, the second end of the connector 202-4 is electrically connected to the at least one switching pin PSW of the second power device chip 202-2 via conductive traces inside the bottom substrate 201. That is, the second end 203-2be of the second winding 203-2 is electrically connected to the switching pin PSW of the second power device chip 202-2 via the connector 202-4. The second end of the connector 202-6 is electrically connected to the bottom substrate 201 via a second output voltage terminal SVOUT2. So, the first end 203-2ae of the second winding 203-2 is electrically connected to the second output voltage terminal SSW2 via the connector 202-6. Thus, the switching pin of PSW of the first power device chip 202-1 is electrically coupled to the top heat layer 202-7 via conductive traces in the bottom substrate 201, the connector 202-3 and the first winding 203-1, and similarly, a switching pin PSW of the second power device chip 202-2 is electrically coupled to the top heat layer 202-8 via conductive traces in the bottom substrate 201, the connector 202-4 and the second winding 203-2. In some embodiments of the present invention, the connectors 202-3, 202-4, 202-5 and 202-6 are soldered to the bottom substrate 201, and the first switching terminal SSW1, the first output voltage terminal SVOUT1, the second switching terminal SSW2 and the second output voltage terminal SVOUT2 are solder pastes connected to the ends of the connectors 202-3, 202-5, 202-4 and 202-6. It should be appreciated that the connectors 202-3, 202-4, 202-5 and 202-6 may be connected to the bottom substrate 201 directly, or by other connecting means known in the art, e.g., the connectors 202-3, 202-4, 202-5 and 202-6 may be protruded out of the bottom surface 202-b of the device substrate 202 and are inserted to grooves of the bottom substrate 201.

As shown in FIG. 7, the first power device chip 202-1 further has signal pins PSIG1 which may be configured to transmit temperature monitoring signal, current monitoring signal, and other necessary signals for communicating between the first power device chip 202-1 and external circuits. The second power device chip 202-2 has signal pins PSIG2 which may be configured to transmit temperature monitoring signal, current monitoring signal, and other necessary signals for communicating between the second power device chip 202-2 and external circuits. In FIG. 7, the driving pin PDRV1 is illustrated as an example of the signal pins PSIG1, and the driving pin PDRV2 is illustrated as an example of the signal pins PSIG2. Other signal pins, like the pins for transmitting the temperature monitoring signal, the current monitoring signal, etc., are not specifically labeled for brevity. The discrete components 202-p together with the first power device chip 202-1 and the second power device chip 202-2 which are molded within the device substrate 202 have connecting terminals on the second surface of the device substrate 202. As shown in the embodiment of FIG. 7, each one of the discrete components 202-p, i.e., the capacitors and the resistors, has two pins or pads exposed at the second surface 202-b of device substrate 202, and is electrically connected to the bottom substrate 201, wherein the discrete components 202-p are electrically connected to the first power device chip 202-1 and the second power device chip 202-2, and external components/circuits via the bottom substrate 201. Persons of ordinary skill in the art should know that the pins shown in FIG. 7 are for illustrating, which should not be limiting the present invention. The pin distribution on the second surface of the device substrate 202 is determined by the requirement of the application specs, and is varying in different applications.

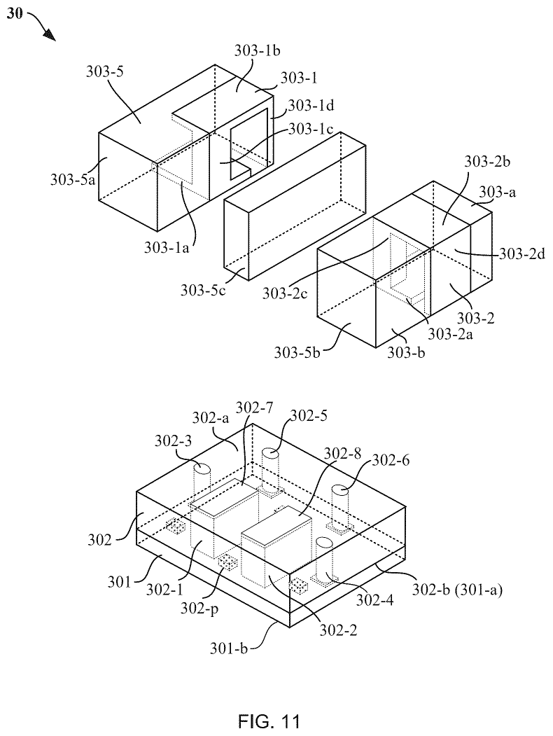

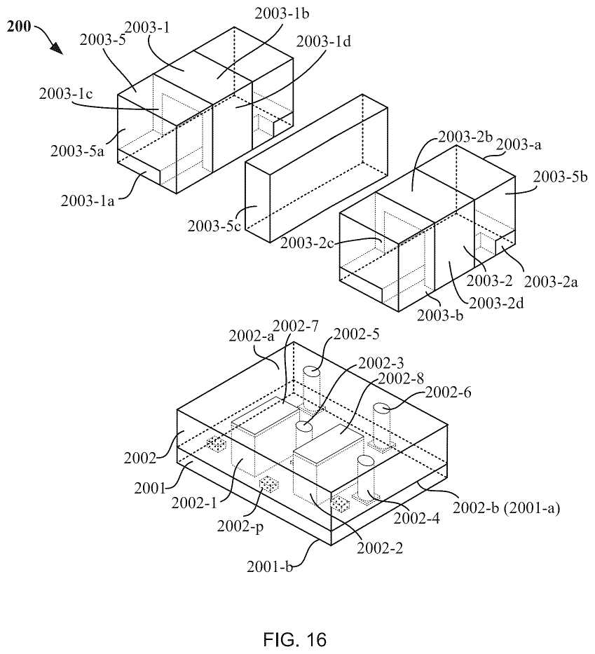

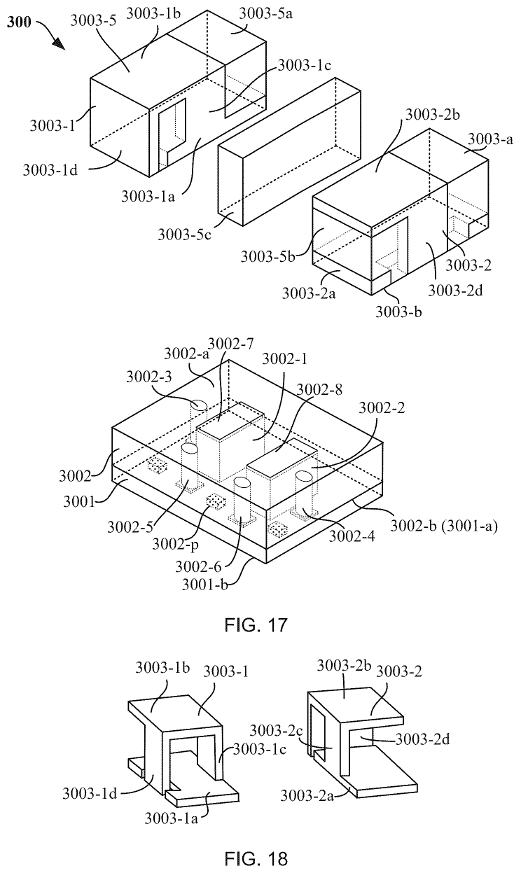

In the present invention, positions of the connectors 202-3 to 202-6 and the corresponding terminals SSW1, SSW2, SVOUT1 and SVOUT2 are placed based on positions of the first ends 203-1ae, 203-2ae and the second ends 203-1be, 203-2be of the first winding 203-1 and second winding 203-2. It is shown in FIG. 6 and FIG. 7 that all of the four connectors 202-3 to 202-6 and the corresponding terminals SSW1, SSW2, SVOUT1 and SVOUT2 are placed next to the short edges of the power device chips 202-1 and 202-2. In the other embodiments, the terminals SSW1, SSW2, SVOUT1, SVOUT2 and the corresponding connection pillars can be placed next to either of the long or short edges of the power device chip, as required (refer to FIG. 11, FIG. 16 and FIG. 17). Moreover, according to an embodiment of the present invention, each of the switching terminal SSW1 and SSW2 may be split into several switching terminals as desired, and the several switching terminals are still used for electrically connecting the connectors and the bottom substrate.

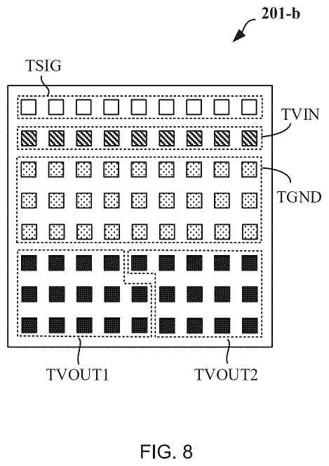

FIG. 8 shows a bottom view of the bottom substrate 201 in accordance with an embodiment of the present invention. The second surface 201-b of the bottom substrate 201 includes a signal pad area TSIG, an input voltage pad area TVIN, a ground pad area TGND, a first output voltage pad area TVOUT1 and a second output voltage pad area TVOUT2. Each one of the pad areas includes a plurality of pads. The pads on the second surface 201-b of the bottom substrate 201 connect through to the first surface 201-a of the bottom substrate 201 using, e.g., vias and conductive traces inside the bottom substrate 201. The plurality of pads of the signal pad area TSIG are electrically connected to the signal pins PSIG1 of the first power device chip 202-1 and the signal pins PSIG2 of the second power device chip 202-2 respectively, like the driving pins PDRV1, PDRV2, temperature monitoring pins, etc. The plurality of pads of the input voltage pad area TVIN are electrically connected to the input pins PVIN of the first power device chip 202-1 and the second power device chip 202-2. The plurality of pads of the ground pad area TGND are electrically connected to the ground pins PGND of the first power device chip 202-1 and the second power device chip 202-2. As can be seen from FIG. 5 to FIG. 8, the plurality of pads of the first output voltage pad area TVOUT1 are electrically connected to the second end 203-1be of the first winding 203-1 via the connector 202-5 and the first output voltage terminal SVOUT1, The plurality of pads of the second output voltage pad area TVOUT2 are electrically connected to the first end 203-2ae of the second winding 203-2 via the connector 202-6 and the second output voltage terminal SVOUT2. In one embodiment, the pads of the first output voltage pad area TVOUT1 and the pads of the second output voltage pad area TVOUT2 are electrically disconnected, which makes the power module 20 work as two independent converters. In some embodiments, the pads of the first output voltage pad area TVOUT1 and the pads of the second output voltage pad area TVOUT2 are electrically connected by external conductive traces or traces inside the bottom substrate, which makes the power module 20 work as a dual-phase power converter.

In the present invention, by stacking the bottom substrate 201, the device substrate 202 and the inductor assembly 203 vertically, the power density is increased. It should be appreciated that the device substrate 202 could also be implemented by other means, e.g., by PCB (Printed Circuit Board) process. Specifically, the power device chips 202-1 and 202-2, the discrete components 202-p, and the connectors 202-3˜202-6 could be integrated in a PCB or be embedded by several PCB layers. In one embodiment, the bottom substrate 201 is implemented by a PCB layer.

FIG. 9A shows a cross-sectional view illustrating the power module 20 taken along line AA′ of FIG. 2 in accordance with an embodiment of the present invention. As previously described in FIG. 3, the first winding 203-1 includes the first portion 203-1a, the second portion 203-1b, the third portion 203-1c and the fourth portion 203-1d. Wherein, the first portion 203-1a extends along the second surface 203-b of the inductor assembly 203, the second portion 203-1b extends along the first surface 203-a of the inductor assembly 203, the third portion 203-1c is perpendicular to the second surface 203-b of the inductor assembly 203, and the fourth portion 203-1d is perpendicular to the second surface 203-b of the inductor assembly 203 as well. The plurality of pins of the first power device chip 202-1 are represented by the shaded regions in FIG. 9A. In the example of FIG. 9A, a current path P1 of a current I1 flowing through the first winding 203-1 is shown with a dashed line, and a flux path P2 induced by the current I1 is shown with a solid line. Specifically, the current I1 flows in from the connector 202-3, flows through the first portion 203-1a of the first winding, and then flows through the third portion 203-1c in a direction from the second surface 203-b to the first surface 203-a. After that, I1 flows through the second portion 203-1b and the fourth portion 203-1d in sequence, and then flows out from the second end 203-1be of the first winding 203-1 through the connector 202-5. According to Ampere's rule, a flux induced by the current I1 forms the closed flux path P2 around the third portion 203-1c of the first winding in a counterclockwise direction.

FIG. 9B shows a cross-sectional view illustrating the power module 20 taken along line BB′ of FIG. 2 in accordance with an embodiment of the present invention. As previously described in FIG. 3, the second winding 203-2 includes the first portion 203-2a, the second portion 203-2b, the third portion 203-2c, and the fourth portion 203-2d. Wherein, the first portion 203-2a extends along the second surface 203-b of the inductor assembly 203, the second portion 203-2b extends along the first surface 203-a of the inductor assembly 203, the third portion 203-2c is perpendicular to the second surface 203-b of the inductor assembly 203, and the fourth portion 203-2d is perpendicular to the second surface 203-b of the inductor assembly 203 as well. The plurality of pins of the second power device chip 202-2 are represented by the shaded regions in FIG. 9B. In the example of FIG. 9B, a current path P3 of a current I2 flowing through the second winding 203-2 is shown with a dashed line, and a flux path P4 induced by the current I2 is shown with a solid line. Different from the current I1, the current I2 flows in from the connector 202-4, flows through the fourth portion 203-2d and flows through the second portion 203-2b, and then flows through the third portion 203-2c in a direction from the first surface 203-a to the second surface 203-b. After that, I2 flows through the first portion 203-2a and flows out from the first end 203-2ae of the second winding 203-2 through the connector 202-6, forming the current path P3. According to Ampere's rule, a flux induced by the current I2 forms the closed flux path P4 around the third portion 203-2c of the second winding 203-2 along the clockwise direction.

As can be seen from FIG. 9A and FIG. 9B, the direction of the current I1 flowing through the third portion 203-1c of the first winding 203-1 is opposite to the direction of the current I2 flowing through the third portion 203-2c of the second winding 203-2, such that the direction of the flux induced by the current I1 and the direction of the flux induced by the current I2 are opposite to each other as well. This leads to an inverse coupling between an inductor formed by the first winding 203-1 (e.g., L-1 in FIG. 1) and the magnetic core 203-5 and an inductor formed by the second winding 203-2 and the magnetic core 203-5 (L-2 in FIG. 1). The inverse coupling between the two inductors provides fast transient to a dual-phase power converter utilizing the inductor assembly 203, and meanwhile provides inductors with low DCR (Direct Current Resistance) for the dual-phase power converter.

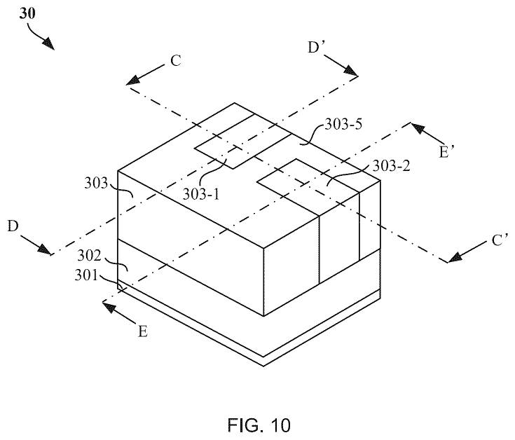

FIG. 10 shows a power module 30 for a dual-phase power converter in accordance with another embodiment of the present invention. The power module 30 may serve as the power stage 102 of FIG. 1, with n=2. The power module 30 includes a bottom substrate 301, a device substrate 302 and an inductor assembly 303. The device substrate 302 is arranged on the bottom substrate 301. The inductor assembly 303 is arranged on the device substrate 302, and comprises a first winding 303-1, a second winding 303-2 and a magnetic core 303-5. The first winding 303-1 and the magnetic core 303-5 form the first inductor L-1 as shown in FIG. 1. The second winding 303-2 and the magnetic core 303-5 form the second inductor L-2 as shown in FIG. 1. Thus the inductors (e.g., L-1 and L-2 in FIG. 1) are integrated in the inductor assembly 303.

FIG. 11 shows a disassembled and perspective view illustrating the power module 30 of FIG. 10. As shown in FIG. 10, the power module 30 includes a bottom substrate 301, a device substrate 302 and an inductor assembly 303.

In the example shown in FIG. 11, the bottom substrate 301 is arranged at the bottom of the power module 30, having a first surface 301-a facing the device substrate 302 and a second surface 301-b opposite to the first surface for external connection. The second surface 301-b of the bottom substrate 301 of the power module 30 comprises a first output voltage pad area and a second output voltage pad area, an input voltage pad area, a ground pad area and a signal pad area, wherein structures and connections of the pad areas on the second surface of the bottom substrate 301 are same as the pad areas on the second surface 201-b of the bottom surface 201 described previously in FIG. 8 and will not be discussed herein for the brevity of description.

As shown in FIG. 11, the device substrate 302 has a first surface 302-a and a second surface 302-b opposite to the first surface 302-a, and the device substrate 302 comprises a first power device chip 302-1, a second power device chip 302-2, a top heat layer 302-7 at least partially covering the first power device chip 302-1, a top heat layer 302-8 at least partially covering the second power device chip 302-2, connectors 302-3, 302-4, 302-5, and 302-6, and a plurality of discrete components 302-p. All these components of the device substrate 302 are at least partially embedded within the device substrate 302. Each of the connectors 302-3, 302-4, 302-5, and 302-6 has a first end exposed at the first surface 302-a of the device substrate 302 and a second end electrically connected to at least one terminal of the second surface 302-b of the device substrate 302.

As shown in FIG. 11, the inductor assembly 303 is disposed above the device substrate 302, and comprises the magnetic core 303-5, the first winding 303-1, and the second winding 303-2. The first winding 303-1 has a first portion 303-1a, a second portion 303-1b, a third portion 303-1c connecting the first portion 303-1a and the second portion 303-1b, and a fourth portion 303-1d connected to the second portion 303-1b. The second winding 303-2 has a first portion 303-2a, a second portion 303-2b, a third portion 303-2c connecting the first portion 303-2a and the second portion 303-2b, and a fourth portion 303-2d connected to the second portion 303-2b. The magnetic core 303-5 comprises a first magnetic core portion 303-5a, a second magnetic core portion 303-5b, and a third magnetic core portion 303-5c. Moreover, the third magnetic core portion 303-5c separates the first winding 303-1 and the second winding 303-2. As shown in FIG. 11, the inductor assembly 303 is disassembled into three portions corresponding to the three magnetic core portion 303-5a to 303-5c for ease of understanding. The inductor assembly 303 has a first surface 303-a and a second surface 303-b, the first surface 303-a and the second surface 303-b are opposite to each other.

The same as described in FIG. 3, the magnetic core 305 may be a single monolithic unit made of a single material or may include a plurality of magnetic core portions made of the same material or different materials. Furthermore, as shown in FIG. 3, the first winding 303-1 and the second winding 303-2 are at least partially embedded within the magnetic core 303-5, each of the first winding 303-1 and the second winding 303-2 may have at least one end exposed at one surface of the magnetic core 303-5.

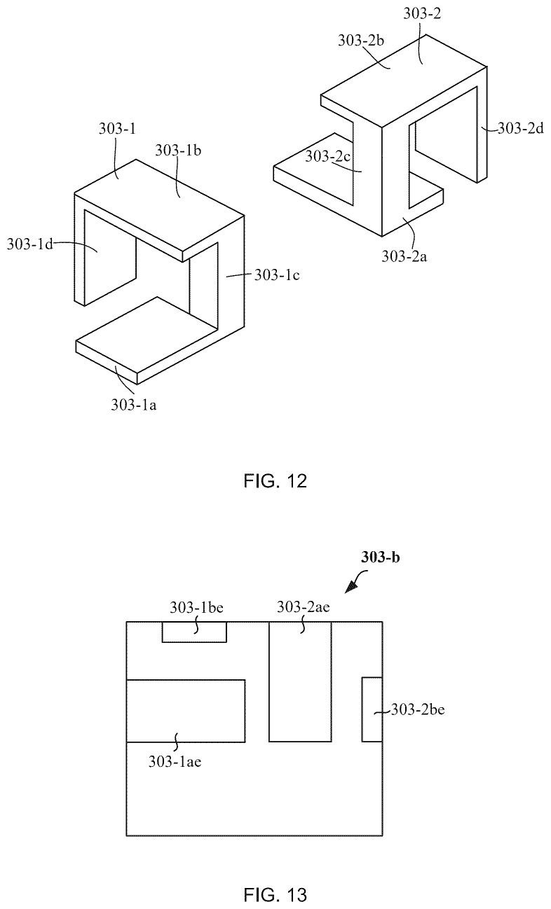

FIG. 12 shows a perspective view of a first winding 303-1 and second winding 303-2 in accordance with an embodiment of the present invention. As shown in FIG. 12, the first winding 303-1 has the first portion 303-1a, the second portion 303-1b, the third portion 303-1c and the fourth portion 303-1d. Similarly, the second winding 303-2 has the first portion 303-2a, the second portion 303-2b, the third portion 303-2c and the fourth portion 303-2d. In the example of FIG. 12, the first portion 303-1a and the second portion 303-1b of the first winding 303-1 are at least partially overlapped in a direction perpendicular to the first surface of the inductor assembly, and the first portion 303-2a and the second portion 303-2b of the second winding 303-2 are at least partially overlapped in the direction perpendicular to the first surface of the inductor assembly as well.

FIG. 13 shows a bottom view of an inductor assembly 303 in accordance with an embodiment of the present invention.

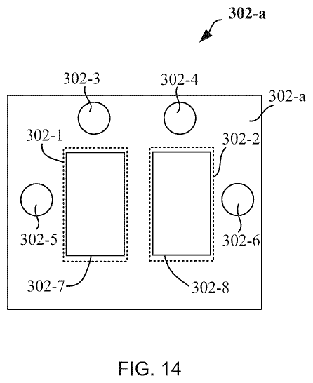

FIG. 14 shows a top view of a device substrate 302 in accordance with an embodiment of the present invention. As shown in FIG. 14, each of the first power device chip 302-1 and the second power device chip 302-2 has two short edges and two long edges at the second surface 302-b of the device substrate. The connector 302-3 is placed next to one of the long edges of the first power device chip 302-1, and the connector 302-5 is placed next to one of the short edges of the first power device chip 302-1. Similarly, the connector 302-4 is placed next to one of the long edges of the second power device chip 302-2, and the connector 302-6 is placed next to one of the short edges of the second power device chip 302-2. Therefore, compare with the power module 20, in the power module 30, the conductive traces inside the bottom substrate 301 connecting switching pins of the first power device chip 302-1 with the first switching terminal and the second switching terminal of the device substrate 302 are shorter. Due to the shorter delivery path, the power module 30 has a higher power efficiency than the power module 20.

The terminals SSW1, SSW2, SVOUT1, and SVOUT2 at the second surface 302-b of the device substrate 302 are electrically connected to the second ends of the connectors 302-3, 302-4, 302-5 and 302-6 respectively. Due to the change in the positions of the connectors 302-3 to 302-6, the positions of the terminals SSW1, SSW2, SVOUT1, and SVOUT2 at the second surface 302-b of the device substrate 302 are changed correspondingly. Except for the locations of the connectors 302-3, 302-4, 302-5, and 302-6 (and corresponding terminals) as described above, the other structures and connections of the device substrate 302 are the same as the device substrate 202 described previously in FIG. 7 and will not be discussed herein for the brevity of description.

According to FIG. 13 and FIG. 14, in an embodiment, when the bottom substrate 301, the device substrate 302 and the inductor assembly 303 are assembled together, the first portion 303-1a of the first winding 303-1 is electrically connected to both the connector 302-3 and the top heat layer 302-7, and the fourth portion 303-1d of the first winding 303-1 is electrically connected to the connector 302-5. Similarly, the first portion 303-2a of the second winding 303-2 is electrically connected to both the connector 302-6 and the top heat layer 302-8, and the fourth portion 303-2d of the second winding 303-2 is electrically connected to the connector 302-4.

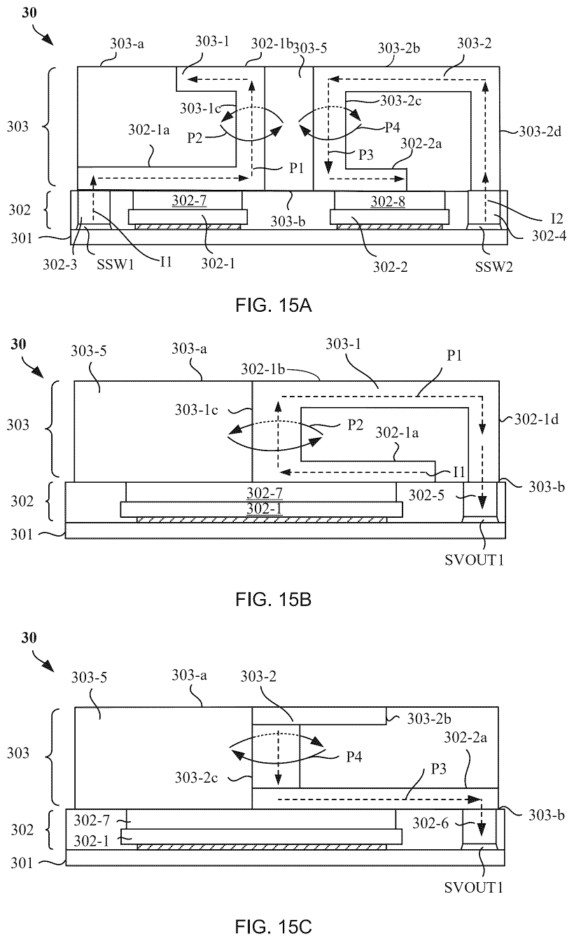

FIG. 15A shows a cross-sectional view illustrating the power module 30 taken along line CC′ of FIG. 10 in accordance with an embodiment of the present invention. FIG. 15B shows a cross-sectional view illustrating the power module 30 taken along line DD′ of FIG. 10 in accordance with an embodiment of the present invention. FIG. 15C shows a cross-sectional view illustrating the power module 30 taken along line EE′ of FIG. 10 in accordance with an embodiment of the present invention. In the example of FIG. 15A to FIG. 15C, a current path P1 of a current I1 flowing through the first winding 303-1 is shown with a dashed line, a flux path P2 induced by the current I1 is shown with a solid line, a current path P3 of the current I2 flowing through the second winding 303-2 is shown with a dashed line, and a flux path P4 induced by the current I2 is shown with a solid line. Moreover, the plurality of pins of the first power device chip 302-1 and the second power device chip 302-2 are represented by the shaded regions in FIG. 15A to FIG. 15C.

As shown in FIG. 15A to FIG. 15C, the current I1 flows in from the connector 302-3, flows through the first portion 303-1a of the first winding and flows through the third portion 303-1c in a direction from the second surface 303-b to the first surface 303-a. After that, I1 flows through the second portion 303-1b and the fourth portion 303-1d in sequence, and then flows out from the second end 303-1be of the first winding 303-1 through the connector 302-5. According to Ampere's rule, a flux induced by the current I1 forms the closed flux path P2 around the third portion 303-1c of the first winding in a counterclockwise direction. Different from the current I1, the current I2 flows in from the connector 302-4, flows through the fourth portion 303-2d and flows through the second portion 303-2b, and then flows through the third portion 303-2c in a direction from the first surface 303-a to the second surface 303-b. After that, I2 flows through the first portion 303-2a and flows out from the first end 303-2ae of the second winding 303-2 through the connector 302-6, forming the current path P3. According to Ampere's rule, a flux induced by the current I2 forms the closed flux path P4 around the third portion 303-2c of the second winding 303-2 along the clockwise direction.

As can be seen from FIG. 15A to FIG. 15C, the direction of the current I1 flowing through the third portion 303-1c of the first winding 303-1 is opposite to the direction of the current I2 flowing through the third portion 303-2c of the second winding 303-2, such that the direction of the flux induced by the current I1 and the direction of the flux induced by the current I2 are opposite to each other as well. This leads to an inverse coupling between an inductor formed by the first winding 303-1 and magnetic core 303-5 and an inductor formed by the second winding 303-2 and the magnetic core 303-5 (e.g. L-1 and L-2 in FIG. 1). The inverse coupling between the two inductors leads to fast transient speed and low DCR which improves the property of the power module.

FIG. 16 shows a disassembled and perspective view illustrating a power module 200 for a dual-phase power converter in accordance with another embodiment of the present invention. And since the power module 200 is structured and arranged in a similar manner as the power module 30, the portions that are the same as the power module 30 will be omitted hereinafter, and the differences will mainly be described.

The power module 200 may serve as the power stage 102 of FIG. 1, with n=2. The power module 200 includes a bottom substrate 2001, a device substrate 2002 and an inductor assembly 2003. The device substrate 2002 is arranged on the bottom substrate 2001. The inductor assembly 2003 is arranged on the device substrate 2002, and comprises a first winding 2003-1, a second winding 2003-2 and a magnetic core 2003-5. The first winding 2003-1 and the magnetic core 2003-5 form the first inductor L-1 as shown in FIG. 1. The second winding 2003-2 and the magnetic core 2003-5 form the second inductor L-2 as shown in FIG. 1. Thus the inductors (e.g., L-1 and L-2 in FIG. 1) are integrated in the inductor assembly 2003.

In the example shown in FIG. 16, the bottom surface 2001 has a first surface 2001-a and a second surface 2001-b opposite to the first surface 2001-a. The second surface 2001-b of the bottom substrate 2001 of the power module 200 comprises a first output voltage pad area and a second output voltage pad area, an input voltage pad area, a ground pad area, a signal pad area, a first trans-inductor pad area and a second trans-inductor pad area. Each one of the pad areas includes a plurality of pads. The structure and connection of the pad areas on the second surface of the bottom substrate 2001 are same as the pad areas on the second surface 201-b of the bottom surface 201 described previously in FIG. 8 and will not be discussed herein for the brevity of description.

As shown in FIG. 16, the device substrate 2002 has a first surface 2002-a and a second surface 2002-b opposite to the first surface 2002-a, and the device substrate 2002 comprises a first power device chip 2002-1, a second power device chip 2002-2, a top heat layer 2002-7 at least partially covering the first power device chip 2002-1, a top heat layer 2002-8 at least partially covering the second power device chip 2002-2, connectors 2002-3, 2002-4, 2002-5, 2002-6 and a plurality of discrete components 2002-p.

As shown in FIG. 16, each of the first power device chip 2002-1 and the second power device chip 2002-2 has two short edges and two long edges at the second surface 2002-b of the device substrate. Each of the first power device chip 2002-1 and the second power device chip 2002-2 has a plurality of pins including at least one switching pin (refer to PSW in FIG. 7). In the example shown in FIG. 16, the connector 2002-3 is placed next to one of the long edges of the first power device chip 2002-1, and the connector 2002-5 is placed next to one of the short edges of the first power device chip 2002-1. Similarly, the connector 2002-4 is placed next to one of the long edges of the second power device chip 2002-2, and the connector 2002-6 is placed next to one of the short edges of the second power device chip 2002-2. Except for the locations of the connectors 2002-3 and 2002-4 (and corresponding switching terminals) as described above, the other structures and connections of the device substrate 2002 are the same as the device substrate 202 of the power module 20 described previously in FIG. 2 to FIG. 9B and will not be discussed herein for the brevity of description.

As shown in FIG. 16, the inductor assembly 2003 is disposed above the device substrate 2002, and comprises the first winding 2003-1, the second winding 2003-2, the magnetic core 2003-5. The first winding 2003-1 has a first portion 2003-1a, a second portion 2003-1b, a third portion 2003-1c connecting the first portion 2003-1a and the second portion 2003-1b, and a fourth portion 2003-1d connected to the second portion 2003-1b. The second winding 2003-2 has a first portion 2003-2a, a second portion 2003-2b, a third portion 2003-2c connecting the first portion 2003-2a and the second portion 2003-2b, and a fourth portion 2003-2d connected to the second portion 2003-2b. In each of the first winding 2003-1 and the second winding 2003-2, the second portion, the third portion, and the fourth portion form an inverted “U” shape together, and the first portion has a shape that mirrors number “7”. The inductor assembly 2003 has a first surface 2003-a and a second surface 2003-b opposite to the first surface 2003-a. The magnetic core 2003-5 comprises a first magnetic core portion 2003-5a, a second magnetic core portion 2003-5b, and a third magnetic core portion 2003-5c. The magnetic core 2005 may be a single monolithic unit made of a single material or may include a plurality of magnetic core portions made of the same material or different materials.

In the example of FIG. 16, when the bottom substrate 2001, the device substrate 2002 and the inductor assembly 2003 are assembled together, a first end of the first winding 2003-1 that is exposed to the second surface 2003-b (i.e., the first end of the first winding 2003-1) is electrically connected to the at least one pad of the first output voltage pad area of the bottom substrate 2001 via the connector 2002-5 and the first output voltage terminal. The first portion 2003-1a of the first winding 2003-1 is also electrically connected to the top heat layer 2002-7. A second end of the fourth portion 2003-1d of the first winding 2003-1 that is exposed to the second surface 2003-b (i.e., the second end of the first winding 2003-1) is electrically connected to the switching pin of the first power device chip 2002-1 and the at least one pad of the input voltage pad area of the bottom substrate 2001 (refer to FIG. 7 and FIG. 8) via the connector 2002-3. A first end of the second winding 2003-2 that is exposed to the second surface 2003-b is electrically connected to the at least one pad of the second output voltage pad area of the bottom substrate 2001 via the connector 2002-6 and the second output voltage terminal. The first portion 2003-2a of the second winding is also electrically connected to the top heat layer 2002-8. A second end of the second winding 2003-2 that is exposed to the second surface 2003-b is electrically connected to the switching pin of the second power device chip 2002-2 and the at least one pad of the input voltage pad area of the bottom substrate 2001 (refer to FIG. 7 and FIG. 8) via the connector 2002-4.

The difference between the power module 200 and the power module 30 will be described in detail herein. As previously shown in FIG. 11 the power module 30 utilizes two windings with the same shape and has the first winding 303-1 and the second winding 303-2 arranged in opposite orientations (e.g., the first portion 303-1a of the first winding 303-1 is oriented in the opposite direction with the first portion 303-2a of the second winding 303-2). Compare with the power module 30, the power module 200 also utilizes two windings with the same shape, but has the first winding 2003-1 and the second winding 2003-2 arranged in the same orientation (e.g., the first portion 2003-1a of the first winding 2003-1 is oriented in the same direction with the first portion 2003-2a of the second winding 2003-2).

In this kind of electrical connection structure, the currents flowing through the fourth portion 2003-1d of the first winding 2003-1 and the third portion 2003-2c of the second winding 2003-2 could have opposite current directions, forms an inverse coupling structure of the power module 200. The inverse coupling structure of the power module 200 provides fast transient to a dual-phase power converter utilizing the inductor assembly 2003, and meanwhile provides inductors with low DCR (Direct Current Resistance) for the dual-phase power converter.

FIG. 17 shows a disassembled and perspective view illustrating a power module 300 for a dual-phase power converter in accordance with another embodiment of the present invention. The power module 300 is a variant embodiment of the power module 30, so the portions that are the same as the power modules 30 will be omitted hereinafter, and the differences will mainly be described.

The power module 300 may serve as the power stage 102 of FIG. 1, with n=2. The power module 300 includes a bottom substrate 3001, a device substrate 3002 and an inductor assembly 3003. The device substrate 3002 is arranged on the bottom substrate 3001. The inductor assembly 3003 is arranged on the device substrate 3002, and comprises a first winding 3003-1, a second winding 3003-2 and a magnetic core 3003-5. The first winding 3003-1 and the magnetic core 3003-5 form the first inductor L-1 as shown in FIG. 1. The second winding 3003-2 and the magnetic core 3003-5 form the second inductor L-2 as shown in FIG. 1.

In the example shown in FIG. 17, the bottom substrate 3001 is arranged at the bottom of the power module 300, having a first surface 3001-a facing the device substrate 3002 and a second surface 3001-b opposite to the first surface for external connection. The second surface 3001-b of the bottom substrate 3001 of the power module 300 comprises a first output voltage pad area and a second output voltage pad area, an input voltage pad area, a ground pad area and a signal pad area, wherein structures and connections of the pad areas on the second surface of the bottom substrate 3001 are same as the bottom surface 301 of the power module 30 described previously in FIG. 10 to FIG. 15C and will not be discussed herein for the brevity of description.

As shown in FIG. 17, the device substrate 3002 has a first surface 3002-a and a second surface 3002-b opposite to the first surface 3002-a, and the device substrate 3002 comprises a first power device chip 3002-1, a second power device chip 3002-2, a top heat layer 3002-7 at least partially covering the first power device chip 3002-1, a top heat layer 3002-8 at least partially covering the second power device chip 3002-2, connectors 3002-3, 3002-4, 3002-5, and 3002-6, and a plurality of discrete components 3002-p. All these components of the device substrate 3002 are at least partially embedded within the device substrate 3002. Each of the connectors 3002-3, 3002-4, 3002-5, and 3002-6 has a first end exposed at the first surface 3002-a of the device substrate 3002 and a second end electrically connected to at least one terminal of the second surface 3002-b of the device substrate 3002. Wherein structures and connections of the device substrate 3002 are same as the device substrate 302 of the power module 30 described previously in FIG. 10 to FIG. 15C and will not be discussed herein for the brevity of description.

As shown in FIG. 17, the inductor assembly 3003 is disposed above the device substrate 3002, and comprises the magnetic core 3003-5, the first winding 3003-1, and the second winding 3003-2. The first winding 3003-1 has a first portion 3003-1a, a second portion 3003-1b, a third portion 3003-1c connecting the first portion 3003-1a and the second portion 3003-1b, and a fourth portion 3003-1d connected to the second portion 3003-1b. The second winding 3003-2 has a first portion 3003-2a, a second portion 3003-2b, a third portion 3003-2c connecting the first portion 3003-2a and the second portion 3003-2b, and a fourth portion 3003-2d connected to the second portion 3003-2b. The magnetic core 3003-5 comprises a first magnetic core portion 3003-5a, a second magnetic core portion 3003-5b, and a third magnetic core portion 3003-5c. Moreover, the third magnetic core portion 3003-5c separates the first winding 3003-1 and the second winding 3003-2. The magnetic core 3005 may be a single monolithic unit made of a single material or may include a plurality of magnetic core portions made of the same material or different materials. The inductor assembly 3003 has a first surface 3003-a and a second surface 3003-b, the first surface 3003-a and the second surface 3003-b are opposite to each other.

In the example of FIG. 17, when the bottom substrate 3001, the device substrate 3002 and the inductor assembly 3003 are assembled together, the first portion 3003-1a of the first winding 3003-1 is electrically connected to the bottom substrate 3001 via the connector 3002-3 to receive a first input signal, and the first portion 3003-1a of the first winding 3003-1 is also electrically connected to the top heat layer 3002-7. The fourth portion 3003-1d of the first winding 3003-1 is electrically connected to the bottom substrate 3001 via the connector 3002-5 to provide a first output signal (e.g., Vout in FIG. 1). The first input signal may represent the input voltage (Vin in FIG. 1), the first output signal may represent the output voltage (Vout in FIG. 1). The fourth portion 3003-2d of the second winding 3003-2 is electrically connected to the bottom substrate 3001 via the connector 3002-4 to receive a second input signal, the first portion 3003-2a of the second winding 3003-2 is electrically connected to the bottom substrate 3001 via the connector 3002-6 to provide a second output signal, and the first portion 3003-2a of the second winding is also electrically connected to the top heat layer 3002-8. The second input signal may represent the input voltage (Vin in FIG. 1), the second output signal may represent the output voltage (Vout in FIG. 1).

In this kind of electrical connection structure, the currents flowing through the third portion 3003-1c of the first winding 3003-1 and the third portion 3003-2c of the second winding 3003-2 could have opposite current directions, forms an inverse coupling structure of the power module 300.

FIG. 18 shows a perspective view of a first winding 3003-1 and second winding 3003-2 in accordance with an embodiment of the present invention.

As shown in FIG. 18, the first winding 3003-1 has the first portion 3003-1a, the second portion 3003-1b, the third portion 3003-1c and the fourth portion 3003-1d. The second portion 3003-1b comprises a top surface exposed at the first surface 3003-a of the inductor assembly 3003, the third portion 3003-1c is perpendicular to the first surface 3003-a and the second surface 3003-b of the inductor assembly 3003, and the fourth portion 3003-1d is perpendicular to the first surface 3003-a and the second surface 3003-b of the inductor assembly 3003 as well.

As shown in FIG. 18, the second winding 3003-2 has the first portion 3003-2a, the second portion 3003-2b, the third portion 3003-2c and the fourth portion 3003-2d. The second portion 3003-2b comprises a top surface exposed at the first surface 3003-a of the inductor assembly 3003, the third portion 3003-2c is perpendicular to the first surface 3003-a and the second surface 3003-b of the inductor assembly 3003, and the fourth portion 3003-2d is perpendicular to the first surface 3003-a and the second surface 3003-b of the inductor assembly 3003 as well.

Moreover, each of the second portion 3003-1b and 3003-2b is parallel to the second surface 3003-b of the inductor assembly and each of the fourth portion 3003-1d and 3003-2d is perpendicular to the second surface 3003-b of the inductor assembly.

The power module 300 differs from the power module 30 in that the power module 30 utilizes two windings with the same shape and has the first winding 303-1 and the second winding 303-1 arranged in opposite orientations, whereas the power module 300 uses two windings with different shapes. Specifically, the fourth portion 3003-1d of the first winding 3003-1 is connected to the long side of the second portion 3003-1b of the first winding 3003-1, and the fourth portion 3003-2d of the second winding 3003-2 is connected to the short side of the second portion 3003-2b of the second winding 3003-2.

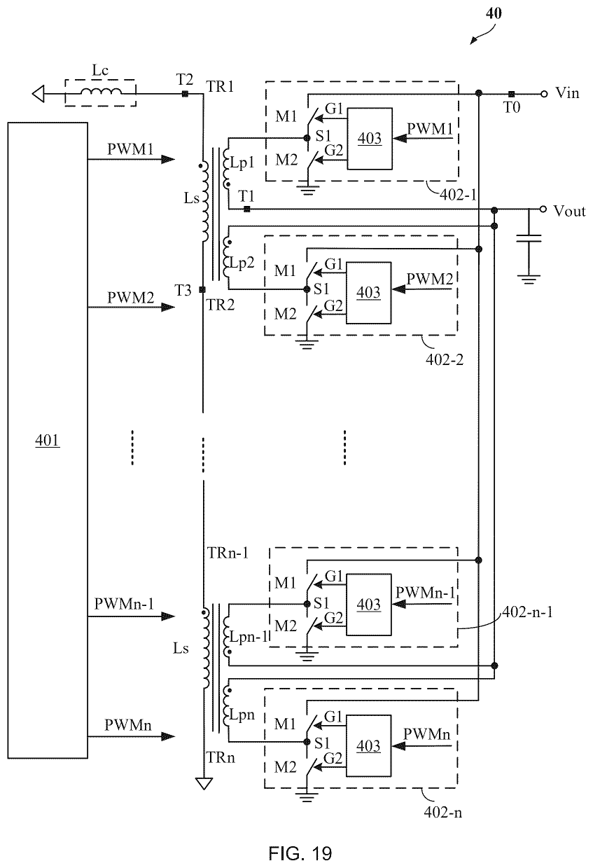

FIG. 19 schematically shows a multi-phase trans-inductor voltage regulator (TLVR) 40 in accordance with an embodiment of the present invention. The multi-phase TLVR 40 includes a controller block 401, n power device blocks 402-1˜402-n and a plurality of transformers TR (includes TR1˜TRn), wherein n is an integer, and n>1. In FIG. 19, a power stage, also referred as a phase of the TLVR 40 includes a power device block 402 and the corresponding transformer TR. Each power device block 402 includes a first power switch M1, a second power switch M2 and a driver 403 for driving the power switches M1 and M2. The first power switch M1 has a first terminal connecting to an input terminal T0 to receive an input voltage Vin, a second terminal connecting to a switching terminal S1, and a control terminal for receiving a driving signal G1 from the driver 403. The second power switch M2 has a first terminal connecting to the switching terminal S1, a second terminal connecting to a ground, and a control terminal for receiving a driving signal G2 from the driver 403. The power switches M1 and M2 are turned on and off by the driver 403 alternately. The driving signals G1 and G2 may be in phase or out of phase, depending on types of the power switch M1 and M2. The controller block 401 provides a plurality of switching control signals PWM1˜PWMn respectively to the corresponding power device block 402. The driver 403 receives the corresponding switching control signal PWM, and converts the switching control signal PWM to suitable driving signals for driving the power switches M1 and M2. It should be noticed that outputs of all phases as shown in FIG. 19 are connected to work as a multi-phase converter. However, each phase output may be separate and independent, and the TLVR 40 thus could work as multiple independent converters which could have different output voltage levels for different load demands.

As shown in FIG. 19, each transformer TR includes a primary winding Lp1-Lpn, and every two transformers share one secondary winding Ls. In order to clearly shown such structure, turns of the secondary winding Ls is exaggeratedly shown in FIG. 19. According to an embodiment of the present invention, the turns ratio of the primary winding and the secondary winding may be 1:1. Each primary winding Lp1-Lpn is coupled between the corresponding power device block 402 and the output voltage Vout, and all the secondary windings Ls are coupled in series.

The TLVR 40 further includes a compensation inductor Lc for suppressing output current ripple and improving system efficiency. The compensation inductor Lc could be eliminated by a controlled leakage inductance between the primary winding Lp1-Lpn and the secondary winding Ls of each transformer TR. Such elimination of the compensation inductor Lc may allow for significant amounts of additional space and an increased power density on the power module with TLVR technology.

In the present invention, n could be any suitable number as required. In some embodiments, n=2, and then the TLVR 40 is used as a dual-phase power converter or two independent single-phase converters.

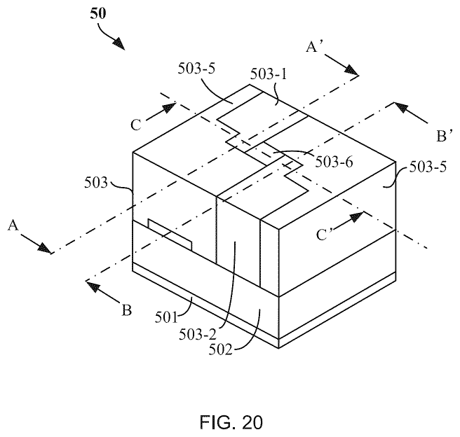

FIG. 20 schematically shows a power module 50 for a dual-phase TLVR in accordance with an embodiment of the present invention. The power module 50 may serve as power stages in FIG. 19, with n=2. The power module 50 includes a bottom substrate 501, a device substrate 502 and an inductor assembly 503. The bottom substrate 501 is arranged at the bottom of the power module 50, the device substrate 502 is arranged on the bottom substrate 501, the inductor assembly 503 is arranged on the device substrate 502. The inductor assembly 503 comprises a first winding 503-1 (e.g., Lp1), a second winding 503-2 (e.g., Lp2), a magnetic core 503-5, and a secondary winding 503-6 (e.g., Ls in FIG. 19). The first winding 503-1, the second winding 503-2 and the secondary winding 503-6 are embedded in the magnetic core 503-5 of the inductor assembly 503, the first winding 503-1 and the second winding 503-2 are at least partially exposed on the surface of the magnetic core 503-5. The first winding 503-1 and the second winding 503-2 are both primary windings. Each of the first winding 503-1 and the second winding 503-2 shares a magnetic core 503-5 and a secondary winding 503-6, i.e., the first winding 503-1, the secondary winding 503-6 and the magnetic core 503-5 form a transformer (e.g., TR1 in FIG. 19), and the second winding 503-2, the secondary winding 503-6 and the magnetic core 503-5 form a transformer (e.g., TR2 in FIG. 19). Thus, the transformers (e.g., transformer TR1 and transformer TR2 in FIG. 19) are integrated in the inductor assembly 503.

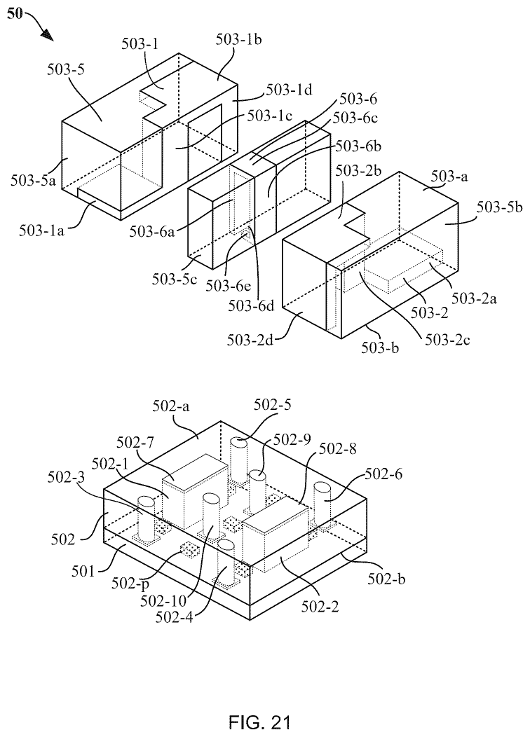

The power module 50 according to an embodiment of the present invention will be further described below with reference to FIG. 21 to FIG. 27. It should be noted that the power module 50 differs from the power module 20 only in that the power module 50 implements a trans-inductor structure with the secondary winding 503-6, and the following will describe in detail about the differences, and appropriately omit the portions that are the same for the power module 50 and the power module 20.

FIG. 21 shows a disassembled and perspective view illustrating the power module 50 of FIG. 20. As shown in FIG. 20, the power module 50 includes the bottom substrate 501, the device substrate 502 and the inductor assembly 503. The device substrate 502 has a first surface 502-a and a second surface 502-b opposite to the first surface 502-a, and the device substrate 502 comprises a first power device chip 502-1, a second power device chip 502-2, a top heat layer 502-7 at least partially covering the first power device chip 502-1, a top heat layer 502-8 at least partially covering the second power device chip 502-2, connectors 502-3 to 502-6, 502-9, 502-10 and a plurality of discrete components 502-p. The discrete components 502-p may include resistors and capacitors of the TLVR 40, like the input capacitors at the input terminal T0 of the TLVR 40 to filter the pulse current and stabilize the input voltage, the decoupling capacitors and resistors for gate driver and internal logic circuits power supplies, etc. Each one of the power device chips 502-7 and 502-8 integrates the power device block 402 in FIG. 19, which includes the power switches M1, M2, the driver 403, and some auxiliary circuits not shown in FIG. 20. Among the connectors 502-3 to 502-6, 502-9 and 502-10, the connectors 502-3 to 502-6 are electrically connected to the primary windings 503-1, 503-2 of the transformer, the connectors 502-9 and 502-10 are electrically connected to the secondary winding 503-6. The connector 502-9 can also be referred to as first trans-inductor connector, and the connector 502-10 can also be referred to as second trans-inductor connector. Moreover, the connectors 502-9 and 502-10 are placed between the first power device chip 502-1 and the second power device chip 502-2. Herein, all these components of the device substrate 502 are at least partially embedded within the device substrate 502.

As shown in FIG. 21, the inductor assembly 503 is disposed above the device substrate 502, and comprises the first winding 503-1, the second winding 503-2, the magnetic core 503-5 and the secondary winding 503-6. The first winding 503-1 has a first portion 503-1a, a second portion 503-1b, a third portion 503-1c connecting the first portion 503-1a and the second portion 503-1b, and a fourth portion 203-1d connected to the second portion 503-1b. The second winding 503-2 has a first portion 503-2a, a second portion 503-2b, a third portion 503-2c connecting the first portion 503-2a and the second portion 503-2b, and a fourth portion 503-1d connected to the second portion 503-1b. The secondary winding 503-6 has a first portion 503-6a, a second portion 503-6b, a third portion 503-6c, a fourth portion 503-6d, and a fifth portion 503-6e. The magnetic core 503-5 comprises a first magnetic core portion 503-5a, a second magnetic core portion 503-5b, and a third magnetic core portion 503-5c. The first winding 503-1 is at least partially embedded in the first magnetic core portion 503-5a, the second winding 503-2 is at least partially embedded in the second magnetic core portion 503-5b. As shown in FIG. 21, the third magnetic core portion 503-5c is disposed between the first magnetic core portion 503-5a and the second magnetic core portion 503-5b, and separates the first winding 503-1 and the second winding 503-2. The inductor assembly 503 is disassembled into three portions corresponding to the three magnetic core portion 503-5a to 503-5c for ease of understanding. The inductor assembly 503 has a first surface 503-a and a second surface 503-b, the first surface 503-a and the second surface 503-b are opposite to each other. The secondary winding 503-6 is at least partially embedded in the third magnetic core portion 503-5c. More specifically, as shown in FIG. 21, the third magnetic core portion 503-5c passes underneath the third portion 503-6c of the secondary winding, occupies the space enclosed by the secondary winding 503-6. That is, the magnetic core 503-5 (at least a portion of the third magnetic core portion 503-5c) passes through the secondary winding 503-6. Since the third magnetic core portion 503-5c is interposed between the first magnetic core portion 503-5a and the second magnetic core portion 503-5b, the secondary winding 503-6 is interposed between the first winding and the second winding.

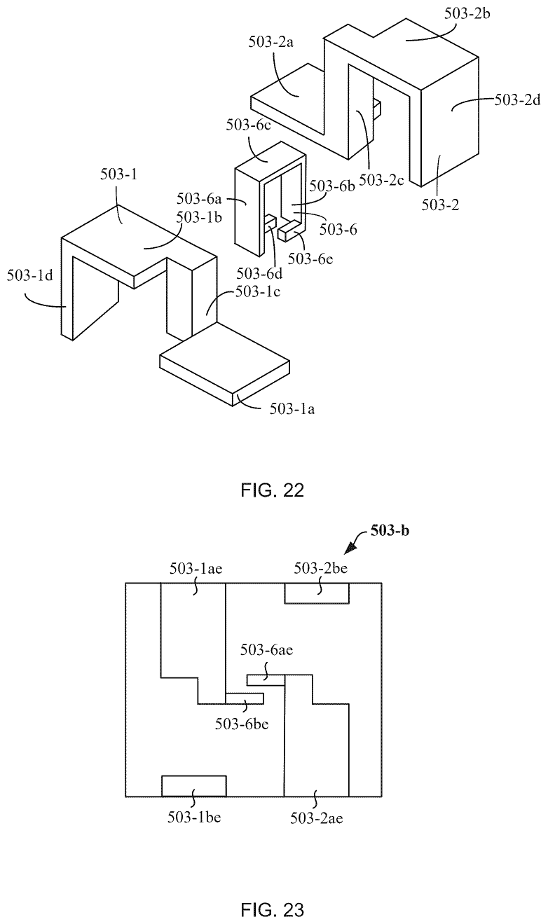

FIG. 22 shows a perspective view of a first winding 503-1, second winding 503-2 and the seondary winding 503-6 in accordance with an embodiment of the present invention.

In the example of FIG. 22, the first winding 503-1 has the first portion 503-1a, the second portion 503-1b, the third portion 503-1c and the fourth portion 503-1d, and similarly, the second winding 503-2 has the first portion 503-2a, the second portion 503-2b, the third portion 503-2c and the fourth portion 503-2d. As previously described, a currents flowing through the third portion 503-1c of the first winding 503-1 and the third portion 503-2c of the second winding 503-2 to have opposite current directions, the first winding 503-1 and the magnetic core 503-5 forms an inverse coupling with the second winding 503-2 and the magnetic core 503-5 (e.g. Lp1 and Lp2 in FIG. 19).

As shown in FIG. 22, the secondary winding 503-6 has the first portion 503-6a, the second portion 503-6b, the third portion 503-6c, the fourth portion 503-6d and the fifth portion 503-6e. The first portion 503-6a of the secondary winding is adjacent to the third portion of the first winding 503-1c. The secondary winding 503-6 comprises a first end 503-6ae and a second end 503-6be exposed at the second surface 503-b of the inductor assembly 503, the first end 503-6ae and the second end 503-6be of the secondary winding 503 are parallel to each other. And the first portion 503-6a is perpendicular to the second surface 503-b of the inductor assembly. The second portion 503-6b of the secondary winding is adjacent to the third portion 503-2c of the second winding and is perpendicular to the second surface 503-b of the inductor assembly. The third portion 503-6c connects the first portion 503-6a and the second portion 503-6b. The fourth portion 503-6d is connected to the first portion 503-6a. The fifth portion 503-6e is connected to the second portion 503-6b, and comprises a second end exposed at the second surface 503-b of the inductor assembly. The fourth portion 503-6d and the fifth portion 503-6e are parallel to each other. The first end 503-6ae is electrically connected to the connector 502-9, the second end 503-6be is electrically connected to the connector 502-10 in order to electrically connected to the corresponding pads on the bottom substrate 501.

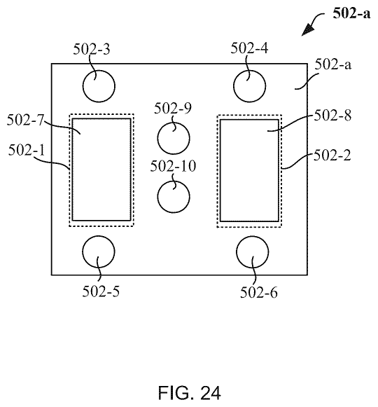

FIG. 23 shows a bottom view of the inductor assembly 503, i.e., the second surface 503-b of the inductor assembly 503, in accordance with an embodiment of the present invention. FIG. 24 shows a top view of the device substrate 502 in accordance with an embodiment of the present invention.

In the example shown in FIG. 24, each of the connectors 502-3 to 502-6, 502-9 and 502-10 has a first end exposed at the first surface 502-a of the device substrate 502 and a second end electrically connected to at least one terminal of the second surface 502-b of the device substrate 502.

The first end 503-1ae of the first winding 503-1 is electrically connected to the first end of the connector 502-3 and the top heat layer 502-7 as shown in FIG. 23 and FIG. 24. The second end 503-1be of the first winding 503-1 is electrically connected to the first end of the connector 502-5 as shown in FIG. 23 and FIG. 24. The second winding 503-2 has the first end 503-2ae electrically connected to the first end of the connector 502-6 and the top heat layer 502-8, and has the second end 503-2be electrically connected to the first end of the connector 502-4. The first end 503-6ae of the secondary winding 503-6 is electrically connected to the first end of the connector 502-9, the second end 503-6be of the secondary winding 503-6 is electrically connected to the first end of the connector 502-10. In one embodiment, the respective ends of the first winding 503-1, the second winding 503-2, and the secondary winding 503-6 may be physically attached to the first end of the corresponding connectors of the device substrate 502 by soldering or via a conductive adhesive.

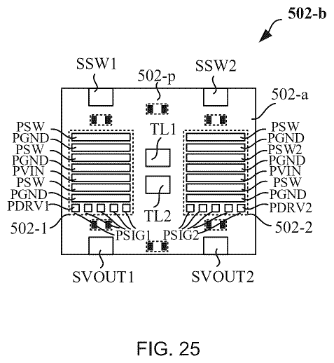

FIG. 25 shows a bottom view of the device substrate 502, i.e., the second surface 502-b of the device substrate 502 in accordance with an embodiment of the present invention. As mentioned before, each one of the power device chips 502-7 and 502-8 integrates the power device block 402 in FIG. 19, which includes the power switches M1, M2, the driver 403, and some auxiliary circuits not shown in FIG. 19. Therefore, each of the first power device chip 502-1 and the second power device chip 502-2 has a plurality of pins including at least an input pin PVIN, at least one switching pin PSW, at least one ground pin PGND, and a driving pin PDRV1 as shown in FIG. 25. And for the sake of brevity, other pins will not be described herein. Taking the first power device chip 502-1 as an example, a common node of the switches M1 and M2 is connected to the at least one switching pin PSW. To be specific, the first switch M1 has a first terminal coupled to the input pin PVIN (corresponding to the input terminal T1 in FIG. 19) to receive the input voltage Vin (shown in FIG. 19), a second terminal connected to the at least one switching pin PSW (corresponding to the switching terminal S1 in FIG. 19), and a control terminal configured to receive a first driving signal G1. The second switch M2 has a first terminal coupled to the at least one switching pin PSW, a second terminal coupled to the ground pin PGND, and a control terminal configured to receive a second driving signal G2. The driver DR1 is coupled to the driving pin PDRV1 to receive a switching control signal PWM shown in FIG. 19, and to provide the first driving signal G1 and the second driving signal G2 based on the switching control signal PWM. The plurality of pins of the first power device chip 502-1 and the second power device chip 502-2 are electrically connected to external circuits/devices/components via the bottom substrate 501. The bottom substrate 501 may be attached to a mainboard where the load (CPU, GPU, etc.) are located, and there may be circuits/devices/components on the mainboard providing the input voltage Vin, the switching control signal PWM, and a ground reference that provides a common ground for the first power device chip 502-1 and the second power device chip 502-2 via the ground pins PGND.

In the example of FIG. 25, the second end of the connector 502-3 is electrically connected to the bottom substrate 501 via a first switching terminal SSW1. Furthermore, the second end of the connector 502-3 is electrically connected to the at least one switching pin PSW of the first power device chip 502-1 via conductive traces inside the bottom substrate 501. The second end of the connector 502-5 is electrically connected to the bottom substrate 501 via a first output voltage terminal SVOUT1. The second end of the connector 502-4 is electrically connected to the bottom substrate 501 via a second switching terminal SSW2. Furthermore, the second end of the connector 502-4 is electrically connected to the at least one switching pin PSW of the second power device chip 502-2 via conductive traces inside the bottom substrate 501. The second end of the connector 502-6 is electrically connected to the bottom substrate 501 via a second output voltage terminal SVOUT2. Thus, the switching pin of PSW of the first power device chip 502-1 is electrically coupled to the top heat layer 502-7 via conductive traces in the bottom substrate 501, the connector 502-3 and the first winding 503-1, and similarly, the switching pin PSW of the second power device chip 502-2 is electrically coupled to the top heat layer 502-8 via conductive traces in the bottom substrate 501, the connector 502-4 and the second winding 503-2. The second end of the connector 502-9 is electrically connected to the bottom substrate 501 via a first trans-inductor terminal TL1, the second end of the connector 502-10 is electrically connected to the bottom substrate 501 via a second trans-inductor terminal TL2. Therefore, the secondary winding 503-6 is electrically connected to the bottom substrate 501 via the connectors 502-9, 502-10, the first trans-inductor terminal TL1 and the second trans-inductor terminal TL2. The discrete components 502-p is molded within the device substrate 502 together with the first power device chip 502-1 and the second power device chip 502-2, and has connecting terminals on the second surface of the device substrate 502.

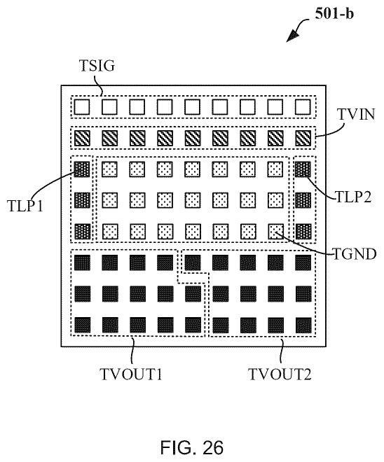

FIG. 26 shows a bottom view of the bottom substrate 501, i.e., the second surface 501-b of the bottom substrate 501, in accordance with an embodiment of the present invention. The second surface 501-b of the bottom substrate 501 includes a signal pad area TSIG, an input voltage pad area TVIN, a ground pad area TGND, a first output voltage pad area TVOUT1, a second output voltage pad area TVOUT2, a first trans-inductor pad area TLP1 and a second trans-inductor pad area TLP2.

Each one of the pad areas includes a plurality of pads. The pads on the second surface 501-b of the bottom substrate 501 connect through to the first surface 501-a of the bottom substrate 501 using, e.g., vias and conductive traces inside the bottom substrate 501. The plurality of pads of the signal pad area TSIG are electrically connected to the signal pins PSIG1 of the first power device chip 502-1 and the signal pins PSIG2 of the second power device chip 502-2 respectively. The plurality of pads of the input voltage pad area TVIN are electrically connected to the input pins PVIN of the first power device chip 502-1 and the second power device chip 502-2. The plurality of pads of the ground pad area TGND are electrically connected to the ground pins PGND of the first power device chip 502-1 and the second power device chip 502-2. The plurality of pads of the first output voltage pad area TVOUT1 are electrically connected to the second end 503-1be of the first winding 503-1 via the connector 502-5. The plurality of pads of the second output voltage pad area TVOUT2 are electrically connected to the first end 503-2ae of the second winding 503-2 via the connector 502-6. The plurality of pads of the first trans-inductor pad area TLP1 are electrically connected to the first end 503-6ae of the secondary winding 503-6 via the connector 502-9. The plurality of pads of the second trans-inductor pad area TL2 are electrically connected to the second end 503-6be of the secondary winding 503-6 via the connector 502-10. At least one pad of the first trans-inductor pad area TLP1 corresponds to the terminal T2 shown in FIG. 19, at least one pad of the second trans-inductor pad area TL2 corresponds to the terminal T3 shown in FIG. 19.

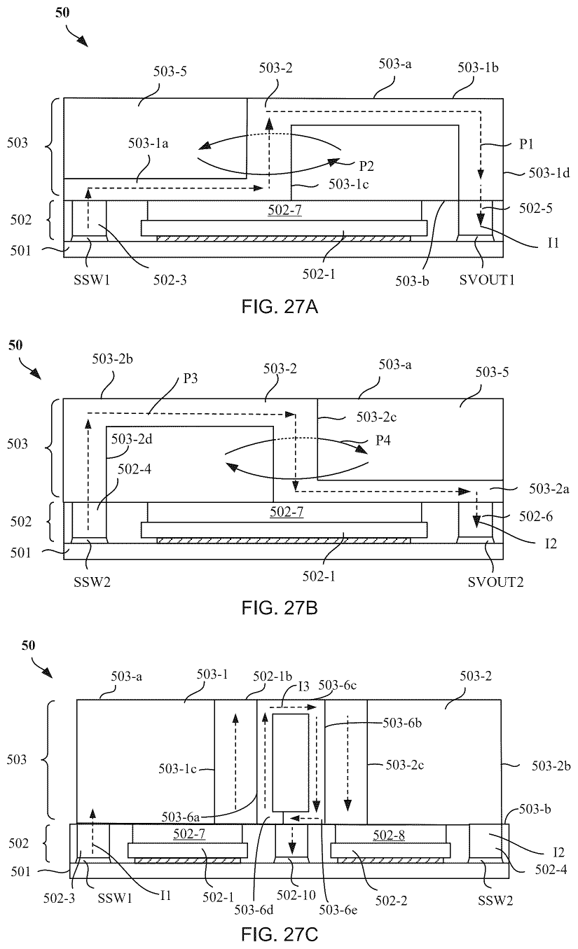

FIG. 27A shows a cross-sectional view illustrating the power module 50 taken along line AA′ of FIG. 20 in accordance with an embodiment of the present invention.

In the example of FIG. 27A, a current path P1 of a current I1 flowing through the first winding 503-1 is shown with a dashed line, and a flux path P2 induced by the current I1 is shown with a solid line. Specifically, the current I1 flows in from the connector 502-3, flows through the first portion 503-1a of the first winding, and then flows through the third portion 503-1c in a direction from the second surface 503-b to the first surface 503-a. After that, I1 flows through the second portion 503-1b and the fourth portion 503-1d in sequence, and then flows out from the second end 503-1be of the first winding 503-1 through the connector 502-5. According to Ampere's rule, a flux induced by the current I1 forms the closed flux path P2 around the third portion 503-1c of the first winding in a counterclockwise direction.

FIG. 27B shows a cross-sectional view illustrating the power module 50 taken along line BB′ of FIG. 20 in accordance with an embodiment of the present invention.

In the example of FIG. 27B, a current path P3 of a current I2 flowing through the second winding 503-2 is shown with a dashed line, and a flux path P4 induced by the current I2 is shown with a solid line. Different from the current I1, the current I2 flows in from the connector 502-4, flows through the fourth portion 503-2d, flows through the second portion 503-2b, and then flows through the third portion 503-2c in a direction from the first surface 503-a to the second surface 503-b. After that, I2 flows through the first portion 503-2a and flows out from the first end 503-2ae of the second winding 503-2 through the connector 502-6, forming the current path P3. According to Ampere's rule, a flux induced by the current I2 forms the closed flux path P4 around the third portion 503-2c of the second winding 503-2 along the clockwise direction.

FIG. 27C shows a cross-sectional view illustrating the power module 50 taken along line CC′ of FIG. 20 in accordance with an embodiment of the present invention.

In the example of FIG. 27C, a current path of a current I3 flowing through the secondary winding 503-6 is shown with a dashed line. Wherein the current I3 flows in from the connector 502-9 (see FIG. 21), and flows through the fourth portion 503-6d of the secondary winding 503-6, then sequentially flows through the first portion 503-6a, the third portion 503-6c, the second portion 503-6b and the fifth portion 503-6e of the secondary winding 503-6 and flows out through the connection pillar 502-10. As shown in FIG. 27C, the direction of the current flowing through the first portion 503-6a of the secondary winding 503-6 is the same as the direction of the current flowing through the third portion 503-1c of the first winding 503-1 adjacent thereto, and the direction of the current flowing through the second portion 503-6b of the secondary winding 503-6 is the same as the direction of the current flowing through the third portion 503-2c of the second winding 503-2 adjacent thereto.

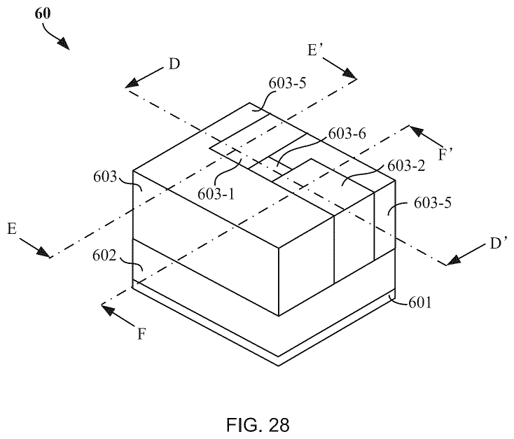

FIG. 28 schematically shows a power module 60 for a dual-phase TLVR in accordance with an embodiment of the present invention. The power module 60 may serve as power stages in FIG. 19, with n=2. The power module 60 includes a bottom substrate 601, a device substrate 602 and an inductor assembly 603. The bottom substrate 601 is arranged at the bottom of the power module 60, the device substrate 602 is arranged on the bottom substrate 601, the inductor assembly 603 is arranged on the device substrate 602. The inductor assembly 603 comprises a first winding 603-1, a second winding 603-2, a magnetic core 603-5, and a secondary winding 603-6 (e.g., Ls in FIG. 19). The first winding 603-1 (e.g., Lp1 in FIG. 19) and the second winding 603-2 (e.g., Lp2 in FIG. 19) are both primary windings. Each of the first winding 603-1 and the second winding 603-2 shares a magnetic core 603-5 and a secondary winding 603-6, i.e., the first winding 603-1, the secondary winding 603-6 and the magnetic core 603-5 are integrated as one transformer (e.g., TR1 in FIG. 19), and the second winding 603-2 and the secondary winding 603-6 and the magnetic core 603-5 are integrated as another transformer (e.g., TR2 in FIG. 19). Thus, the transformers are integrated in the inductor assembly 603.

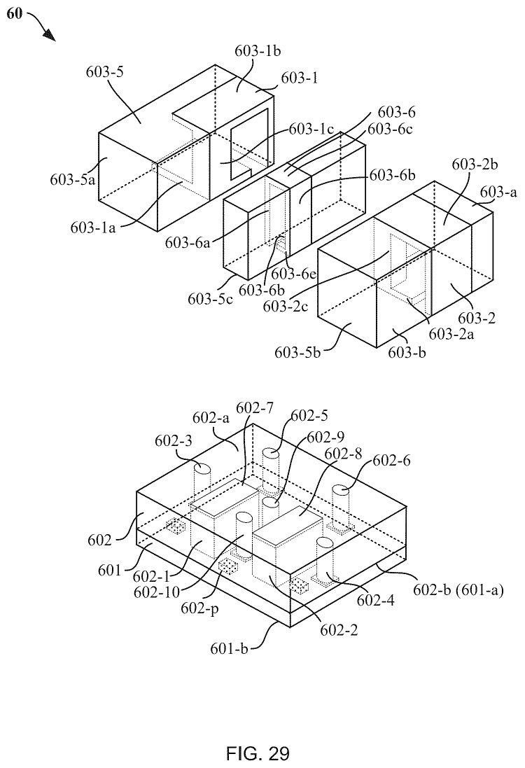

FIG. 29 shows a disassembled and perspective view illustrating the power module 60 of FIG. 28. As shown in FIG. 28, the power module 60 includes a bottom substrate 601, a device substrate 602 and an inductor assembly 603.

In the example shown in FIG. 29, the bottom surface 601 has a first surface 601-a and a second surface 601-b opposite to the first surface 601-a. The second surface 601-b of the bottom substrate 601 of the power module 60 comprises a first output voltage pad area and a second output voltage pad area, an input voltage pad area, a ground pad area, a signal pad area, a first trans-inductor pad area and a second trans-inductor pad area. The structure and connection of the pad areas on the second surface of the bottom substrate 601 are same as the pad areas on the second surface 601-b of the bottom surface 601 described previously in FIG. 26 and will not be discussed herein for the brevity of description.

As shown in FIG. 29, the device substrate 602 has a first surface 602-a and a second surface 602-b opposite to the first surface 602-a, and the device substrate 602 comprises a first power device chip 602-1, a second power device chip 602-2, a top heat layer 602-7 at least partially covering the first power device chip 602-1, a top heat layer 602-8 at least partially covering the second power device chip 602-2, connectors 602-3, 602-4, 602-5, 602-6, 602-9 and 602-10 and a plurality of discrete components 602-p, wherein all these components of the device substrate 602 are at least partially embedded within the device substrate 602. Each of the connectors 602-3, 602-4, 602-5, 602-6, 602-9 and 602-10 has a first end exposed at the first surface 602-a of the device substrate 602 and a second end electrically connected to at least one terminal of the second surface 602-b of the device substrate 602.

As shown in FIG. 29, each of the first power device chip 602-1 and the second power device chip 602-2 has two short edges and two long edges at the second surface 602-b of the device substrate. In the example shown in FIG. 29, the connectors 602-9 and 602-10 are placed between the first power device chip 602-1 and the second power device chip 602-2. Moreover, the connectors 602-9 and 602-10 are placed next to the long edges of the first power device 602-1 and the second power device 602-2 facing each other. The second end of the connector 602-9 is electrically connected to a first trans-inductor terminal TL1 at the second surface 602-b of the device substrate 602, and a second end of the connector 602-10 is electrically connected to a second trans-inductor terminal TL2 at the second surface 602-b of the device substrate 602.

The connector 602-3 is placed next to one of the long edges of the first power device chip 602-1, and the connectors 602-5 is placed next to one of the short edges of the first power device chip 602-1. Similarly, the connector 602-4 is placed next to one of the long edges of the second power device chip 602-2, and the connector 602-6 is placed next to one of the short edges of the second power device chip 602-2. The terminals SSW1, SSW2, SVOUT1, and SVOUT2 at the second surface 602-b of the device substrate 602 are electrically connected to the second ends of the connectors 602-3, 602-4, 602-5 and 602-6 respectively. Due to the change in the positions of the connectors 602-3 to 602-6, the positions of the terminals SSW1, SSW2, SVOUT1, and SVOUT2 at the second surface 602-b of the device substrate 602 are changed correspondingly. Except for the locations of the connectors 602-3, 602-4, 602-5, and 602-6 (and corresponding terminals) as described above, the other structures and connections of the device substrate 602 are the same as the device substrate 502 described previously in FIG. 25 and will not be discussed herein for the brevity of description.

As shown in FIG. 29, the inductor assembly 603 is disposed above the device substrate 602, and comprises the first winding 603-1, the second winding 603-2, the magnetic core 603-5 and the secondary winding 603-6. The first winding 603-1 has a first portion 603-1a, a second portion 603-1b, a third portion 603-1c connecting the first portion 603-1a and the second portion 603-1b, and a fourth portion 603-1d connected to the second portion 603-1b. The second winding 603-2 has a first portion 603-2a, a second portion 603-2b, a third portion 603-2c connecting the first portion 603-2a and the second portion 603-2b, and a fourth portion 603-2d connected to the second portion 603-2b. The secondary winding 603-6 comprises a first end 603-6ae and a second end 603-6be exposed at the second surface 603-b of the inductor assembly 603, the first end 603-6ae and the second end 603-6be of the secondary winding 603 are parallel to each other. The secondary winding 603-6 has a first portion 603-6a, a second portion 603-6b, a third portion 603-6c, a fourth portion 603-6d and a fifth portion 603-6e. The inductor assembly 603 has a first surface 603-a and a second surface 603-b opposite to the first surface 603-a. The magnetic core 603-5 comprises a first magnetic core portion 603-5a, a second magnetic core portion 603-5b, and a third magnetic core portion 603-5c. The magnetic core 605 may be a single monolithic unit made of a single material or may include a plurality of magnetic core portions made of the same material or different materials. The secondary winding 603-6 is at least partially embedded in the third magnetic core portion 603-5c. The magnetic core 603-5 (at least a portion of the third magnetic core portion 603-5c) passes through the secondary winding 603-6. The first portion 606-a of the secondary winding is adjacent to the third portion of the first winding 603-1c, and second portion 606-b of the secondary winding is adjacent to the third portion 603-2c of the second winding.

In the example of FIG. 29, when the bottom substrate 601, the device substrate 602 and the inductor assembly 603 are assembled together, the first portion 603-1a of the first winding 603-1 is electrically connected to the bottom substrate 601 via the connector 602-3 to receive a first input signal, and the first portion 603-1a of the first winding 603-1 is also electrically connected to the top heat layer 602-7. The fourth portion 603-1d of the first winding 603-1 is electrically connected to the bottom substrate 601 via the connector 602-5 to provide a first output signal. The first input signal may represent the input voltage (Vin in FIG. 19), the first output signal may represent the output voltage (Vout in FIG. 19). The fourth portion 603-2d of the second winding 603-2 is electrically connected to the bottom substrate 601 via the connector 602-4 to receive a second input signal, the first portion 603-2a of the second winding 603-2 is electrically connected to the bottom substrate 601 via the connector 602-6 to provide a second output signal, and the first portion 603-2a of the second winding is also electrically connected to the top heat layer 602-8. The second input signal may represent the input voltage (Vin in FIG. 19), the second output signal may represent the output voltage (Vout in FIG. 19).

In this kind of electrical connection structure, the currents flowing through the third portion 603-1c of the first winding 603-1 and the third portion 603-2c of the second winding 603-2 could have opposite current directions, forms an inverse coupling structure of the power module 60. The inverse coupling structure of the power module 60 provides fast transient to a dual-phase TLVR utilizing the inductor assembly 603, and meanwhile provides inductors with low DCR (Direct Current Resistance) for the dual-phase TLVR.

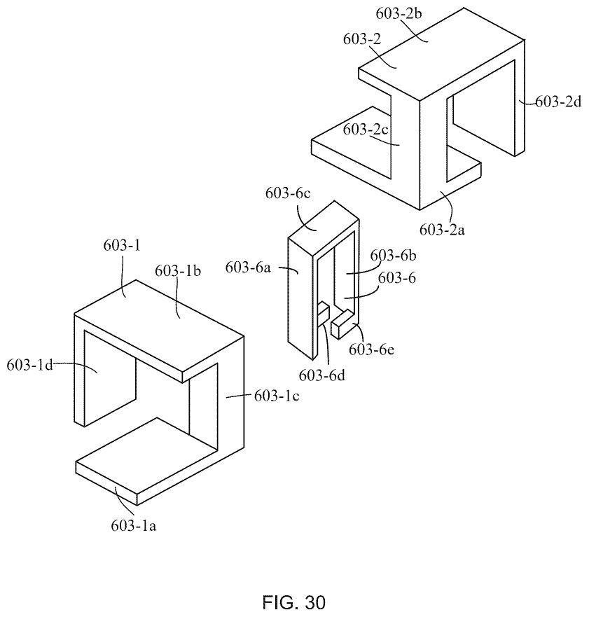

FIG. 30 shows a perspective view of a first winding 603-1, second winding 603-2 and the seondary winding 603-6 in accordance with an embodiment of the present invention.

In the embodiment shown FIG. 30, the first winding 603-1 has the first portion 603-1a, the second portion 603-1b, the third portion 603-1c connecting the first portion 603-1a and the second portion 603-1b, and a fourth portion 603-1d connected to the second portion 603-1b. Similarly, the second winding 603-2 has a first portion 603-2a, a second portion 603-2b, a third portion 603-2c connecting the first portion 603-2a and the second portion 603-2b, and a fourth portion 603-2d connected to the second portion 603-2b. In one embodiment, the structures and connections of the first winding 603-1 and the second winding 603-2 of the power module 60 are the same as the first winding 303-1 and the second winding 303-2 of the power module 30 described previously in FIG. 10 to FIG. 12. The secondary winding 603-6 is at least partially embedded in the third magnetic core portion 603-5c. The magnetic core 603-5 (at least a portion of the third magnetic core portion 603-5c) passes through the secondary winding 603-6. The secondary winding 603-6 has a first portion 603-6a, a second portion 603-6b, a third portion 603-6c, a fourth portion 603-6d, and a fifth portion 603-6e. The first portion 603-6a of the secondary winding is adjacent to the third portion of the first winding 603-1c, and the second portion 603-6b of the secondary winding is adjacent to the third portion 603-2c of the second winding. The third portion 603-6c of the secondary winding connects the first portion 603-6a and the second portion 603-6b. The fourth portion 503-6d is connected to the first portion 503-6a. The fifth portion 603-6e is connected to the second portion 603-6b, and comprises a second end exposed at the second surface 603-b of the inductor assembly.

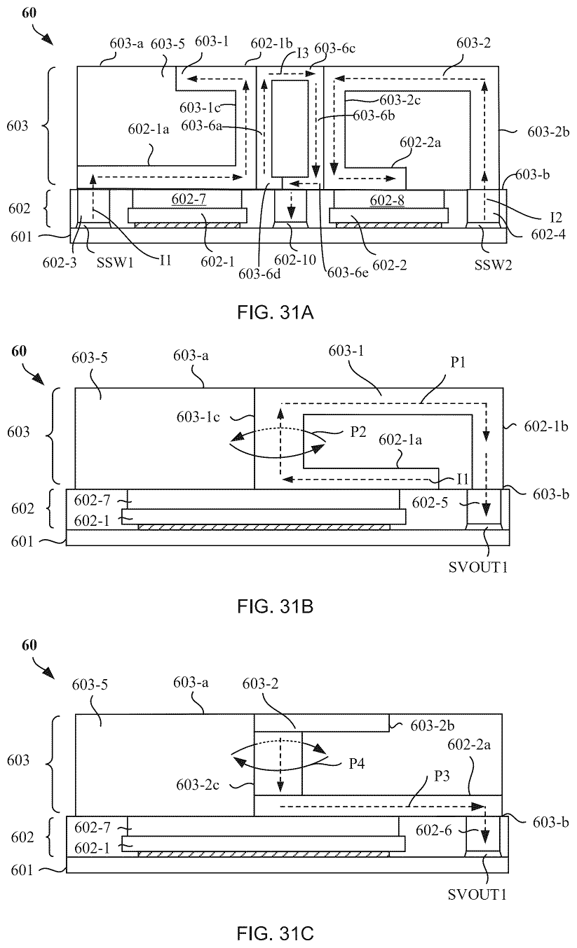

FIG. 31A shows a cross-sectional view illustrating the power module 60 taken along line DD′ of FIG. 28 in accordance with an embodiment of the present invention. FIG. 31B shows a cross-sectional view illustrating the power module 60 taken along line EE′ of FIG. 28 in accordance with an embodiment of the present invention. FIG. 31C shows a cross-sectional view illustrating the power module 60 taken along line FF′ of FIG. 28 in accordance with an embodiment of the present invention.

In the example of FIG. 31A to FIG. 31C, a current path P1 of a current I1 flowing through the first winding 603-1 is shown with a dashed line, a flux path P2 induced by the current I1 is shown with a solid line, a current path P3 of the current I2 flowing through the second winding 603-2 is shown with a dashed line, and a flux path P4 induced by the current I2 is shown with a solid line. Moreover, the plurality of pins of the first power device chip 602-1 and the second power device chip 602-2 are represented by the shaded regions in FIG. 31A to FIG. 31C.

In the example of FIG. 31A, a current path of a current I3 flowing through the secondary winding 603-6 is shown with a dashed line. Wherein the current I3 flows in from the connector 602-9 (see FIG. 29), and flows through the fourth portion 603-6d of the secondary winding 603-6, then sequentially flows through the first portion 603-6a, the third portion 603-6c, the second portion 603-6b and the fifth portion 603-6e of the secondary winding 603-6 and flows out through the connection pillar 602-10. As shown in FIG. 31A, the direction of the current flowing through the first portion 603-6a of the secondary winding 603-6 is the same as the direction of the current flowing through the third portion 603-1c of the first winding 603-1 adjacent thereto, and the direction of the current flowing through the second portion 603-6b of the secondary winding 603-6 is the same as the direction of the current flowing through the third portion 603-2c of the second winding 603-2 adjacent thereto.

As can be seen from FIG. 31A to FIG. 31C, the direction of the current I1 flowing through the third portion 603-1c of the first winding 603-1 is opposite to the direction of the current I2 flowing through the third portion 603-2c of the second winding 603-2, such that the direction of the flux induced by the current I1 and the direction of the flux induced by the current I2 are opposite to each other as well. This leads to an inverse coupling between an inductor formed by the first winding 603-1 and magnetic core 603-5 and an inductor formed by the second winding 603-2 and the magnetic core 603-5. The inverse coupling between the two inductors leads to fast transient speed and low DCR which improves the property of the power module.

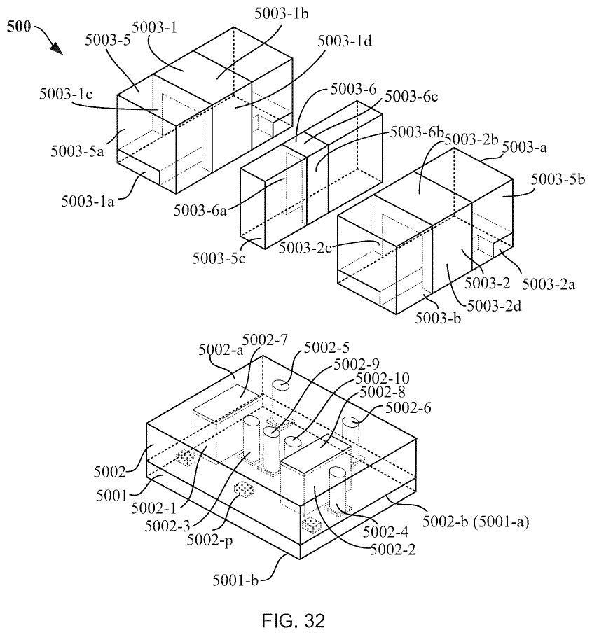

FIG. 32 shows a disassembled and perspective view illustrating a power module 500 for a dual-phase TLVR in accordance with an embodiment of the present invention.

The power module 500 may serve as power stages in FIG. 19, with n=2. The power module 500 includes a bottom substrate 5001, a device substrate 5002 and an inductor assembly 5003. The bottom substrate 5001 is arranged at the bottom of the power module 500, the device substrate 5002 is arranged on the bottom substrate 5001, the inductor assembly 5003 is arranged on the device substrate 5002. The inductor assembly 5003 comprises a first winding 5003-1, a second winding 5003-2, a magnetic core 5003-5, and a secondary winding 5003-6 (e.g., Ls in FIG. 19). The first winding 5003-1 (e.g., Lp1 in FIG. 19) and the second winding 5003-2 (e.g., Lp2 in FIG. 19) are both primary windings. Each of the first winding 5003-1 and the second winding 5003-2 shares a magnetic core 5003-5 and a secondary winding 5003-6, i.e., the first winding 5003-1, the secondary winding 5003-6 and the magnetic core 5003-5 are integrated as one transformer (e.g., TR1 in FIG. 19), and the second winding 5003-2 and the secondary winding 5003-6 and the magnetic core 5003-5 are integrated as another transformer (e.g., TR2 in FIG. 19). Thus, the transformers are integrated in the inductor assembly 5003.

In the example shown in FIG. 32, the bottom surface 5001 has a first surface 5001-a and a second surface 5001-b opposite to the first surface 5001-a. The second surface 5001-b of the bottom substrate 5001 of the power module 500 comprises a first output voltage pad area and a second output voltage pad area, an input voltage pad area, a ground pad area, a signal pad area, a first trans-inductor pad area and a second trans-inductor pad area. The structure and connection of the bottom substrate 5001 are same as the second surface 5001-b of the bottom surface 5001 described previously in FIG. 26 and will not be discussed herein for the brevity of description.

As shown in FIG. 32, the device substrate 5002 has a first surface 5002-a and a second surface 5002-b opposite to the first surface 5002-a, and the device substrate 5002 comprises a first power device chip 5002-1, a second power device chip 5002-2, a top heat layer 5002-7 at least partially covering the first power device chip 5002-1, a top heat layer 5002-8 at least partially covering the second power device chip 5002-2, connectors 5002-3, 5002-4, 5002-5, 5002-6, 5002-9 and 5002-10 and a plurality of discrete components 5002-p, wherein all these components of the device substrate 5002 are at least partially embedded within the device substrate 5002. Each of the connectors 5002-3, 5002-4, 5002-5, 5002-6, 5002-9 and 5002-10 has a first end exposed at the first surface 5002-a of the device substrate 5002 and a second end electrically connected to at least one terminal of the second surface 5002-b of the device substrate 5002. The first ends of the connectors are electrically connected to the corresponding windings.

The device substrate 5002 differs from the device substrate 2002 in that the device substrate 5002 additionally has the connector 5002-9, the connector 5002-10, a first trans-inductor terminal TL1 and a second trans-inductor terminal TL2. Specifically, the connection pillars 5002-9 and 5002-10 are sandwiched between long edges of the first power device chip 5002-1 and the second power device chip 5002-2. The first trans-inductor terminal TL1 is connected to the second end of the connector 5002-9 at the second surface of the device substrate 5002-b, the second trans-inductor terminal TL2 is connected to the second end of the connector 5002-10 at the second surface of the device substrate 5002-b. The connectors 5002-9, 5002-10 and the corresponding transconductance terminals TL1, TL2 may be arranged in any relative position as desired.

As shown in FIG. 32, the inductor assembly 5003 is disposed above the device substrate 5002, and comprises the first winding 5003-1, the second winding 5003-2, the magnetic core 5003-5 and the secondary winding 5003-6. The first winding 5003-1 has a first portion 5003-1a, a second portion 5003-1b, a third portion 5003-1c connecting the first portion 5003-1a and the second portion 5003-1b, and a fourth portion 5003-1d connected to the second portion 5003-1b. The second winding 5003-2 has a first portion 5003-2a, a second portion 5003-2b, a third portion 5003-2c connecting the first portion 5003-2a and the second portion 5003-2b, and a fourth portion 5003-2d connected to the second portion 5003-2b. The secondary winding 5003-6 has a first portion 5003-6a, a second portion 5003-6b, a third portion 5003-6c. The inductor assembly 5003 has a first surface 5003-a and a second surface 5003-b opposite to the first surface 5003-a. The magnetic core 5003-5 comprises a first magnetic core portion 5003-5a, a second magnetic core portion 5003-5b, and a third magnetic core portion 5003-5c. The magnetic core 5005 may be a single monolithic unit made of a single material or may include a plurality of magnetic core portions made of the same material or different materials.

The inductor assembly 5003 differs from the inductor assembly 2003 in that the device substrate 5002 additionally has the secondary winding 5003-6. Specifically, the secondary winding 5003-6 is at least partially embedded in the third magnetic core portion 5003-5c. The magnetic core 5003-5 (at least a portion of the third magnetic core portion 5003-5c) passes through the secondary winding 5003-6. The first portion 5006-a of the secondary winding is adjacent to the fourth portion of the first winding 5003-1d. The second portion 5006-b of the secondary winding is adjacent to the third portion 5003-2c of the second winding.

In the example of FIG. 32, when the bottom substrate 5001, the device substrate 5002 and the inductor assembly 5003 are assembled together, the first portion 5003-6a of the secondary winding 5003-6 is electrically connected to at least one pad of the first trans-inductor pad area TLP1 (refer to FIG. 25 and FIG. 26) via the connector 5002-9 and the first trans-inductor terminal TL1. The second portion 5003-6b of the secondary winding 5003-6 is electrically connected to at least one pad of the second trans-inductor pad area TLP2 (refer to FIG. 25 and FIG. 26) via the connector 5002-10 and the second trans-inductor terminal TL2.

In an embodiment of the present invention, the secondary winding 5003-6 of the power module 500 can be replaced by the secondary winding 503-6 shown in FIG. 22.

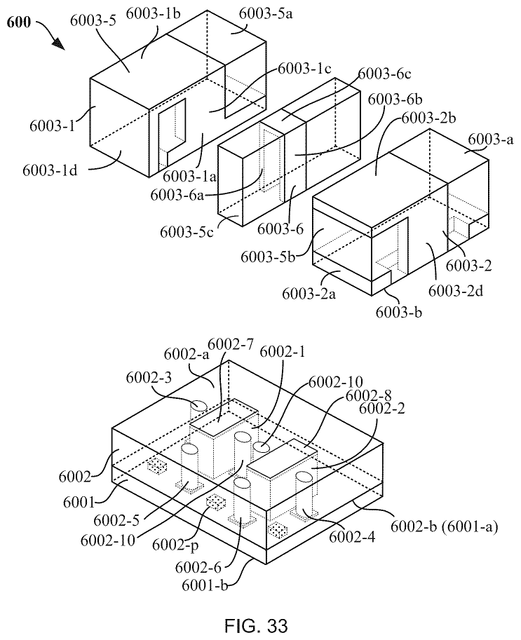

FIG. 33 shows a disassembled and perspective view illustrating a power module 600 for a dual-phase TLVR in accordance with an embodiment of the present invention.

The power module 600 may serve as power stages in FIG. 19, with n=2. The power module 600 includes a bottom substrate 6001, a device substrate 6002 and an inductor assembly 6003. The bottom substrate 6001 is arranged at the bottom of the power module 600, the device substrate 6002 is arranged on the bottom substrate 6001, the inductor assembly 6003 is arranged on the device substrate 6002. The inductor assembly 6003 comprises a first winding 6003-1, a second winding 6003-2, a magnetic core 6003-5, and a secondary winding 6003-6 (e.g., Ls in FIG. 19). The first winding 6003-1 (e.g., Lp1 in FIG. 19) and the second winding 6003-2 (e.g., Lp2 in FIG. 19) are both primary windings. Each of the first winding 6003-1 and the second winding 6003-2 shares a magnetic core 6003-5 and a secondary winding 6003-6.

In the example shown in FIG. 33, the bottom surface 6001 has a first surface 6001-a and a second surface 6001-b opposite to the first surface 6001-a. As shown in FIG. 33, the device substrate 6002 has a first surface 6002-a and a second surface 6002-b opposite to the first surface 6002-a, and the device substrate 6002 comprises a first power device chip 6002-1, a second power device chip 6002-2, a top heat layer 6002-7 at least partially covering the first power device chip 6002-1, a top heat layer 6002-8 at least partially covering the second power device chip 6002-2, connectors 6002-3, 6002-4, 6002-5, 6002-6, 6002-9 and 6002-10 and a plurality of discrete components 6002-p, wherein all these components of the device substrate 6002 are at least partially embedded within the device substrate 6002.

The device substrate 6002 differs from the device substrate 3002 in that the device substrate 6002 additionally has the connector 6002-9, the connector 6002-10, a first trans-inductor terminal TL1 and a second trans-inductor terminal TL2.

As shown in FIG. 33, the inductor assembly 6003 is disposed above the device substrate 6002, and comprises the first winding 6003-1, the second winding 6003-2, the magnetic core 6003-5 and the secondary winding 6003-6. The first winding 6003-1 has a first portion 6003-1a, a second portion 6003-1b, a third portion 6003-1c connecting the first portion 6003-1a and the second portion 6003-1b, and a fourth portion 6003-1d connected to the second portion 6003-1b. The second winding 6003-2 has a first portion 6003-2a, a second portion 6003-2b, a third portion 6003-2c connecting the first portion 6003-2a and the second portion 6003-2b, and a fourth portion 6003-2d connected to the second portion 6003-2b. The secondary winding 6003-6 has a first portion 6003-6a, a second portion 6003-6b and a third portion 6003-6c connecting the first portion 6003-6a and the second portion 6003-6b. The inductor assembly 6003 has a first surface 6003-a and a second surface 6003-b opposite to the first surface 6003-a. The magnetic core 6003-5 comprises a first magnetic core portion 6003-5a, a second magnetic core portion 6003-5b, and a third magnetic core portion 6003-5c.

The inductor assembly 6003 differs from the inductor assembly 3003 in that the device substrate 6002 additionally has a secondary winding 6003-6. Specifically, the first portion 6006-a of the secondary winding is adjacent to the third portion of the first winding 6003-1c. The second portion 6006-b of the secondary winding is adjacent to the third portion 6003-2c of the second winding and comprises a second end exposed at the second surface 6003-b of the inductor assembly.

In the example of FIG. 33, when the bottom substrate 6001, the device substrate 6002 and the inductor assembly 6003 are assembled together, the first portion 6003-6a of the secondary winding 6003-6 is electrically connected to at least one pad of the first trans-inductor pad area TLP1 (refer to FIG. 25 and FIG. 26) via the connector 6002-9 and the first trans-inductor terminal TL1. The second portion 6003-6b of the secondary winding 6003-6 is electrically connected to at least one pad of the second trans-inductor pad area TLP2 (refer to FIG. 25 and FIG. 26) via the connector 6002-10 and the second trans-inductor terminal TL2.

Obviously many modifications and variations of the present invention are possible in light of the above teachings. It is therefore to be understood that within the scope of the appended claims the invention may be practiced otherwise than as specifically described. It should be understood, of course, the foregoing disclosure relates only to a preferred embodiment (or embodiments) of the invention and that numerous modifications may be made therein without departing from the spirit and the scope of the invention as set forth in the appended claims. Various modifications are contemplated and they obviously will be resorted to by those skilled in the art without departing from the spirit and the scope of the invention as hereinafter defined by the appended claims as only a preferred embodiment(s) thereof has been disclosed.

I/We claim:

1. A power module, comprising:
an inductor assembly having a first surface and a second surface opposite to each other, wherein the inductor assembly comprises a magnetic core, a first winding and a second winding at least partially embedded within the magnetic core, each of the first winding and the second winding comprises:
a first portion;
a second portion comprising a top surface exposed at the first surface of the inductor assembly;
a third portion connecting the first portion and the second portion;
a fourth portion connected to the second portion; and
a device substrate below the inductor assembly, the device substrate has a first surface and a second surface opposite to each other, and comprises a first power device chip and a second power device chip, wherein the first power device chip and the second power device chip are embedded in the device substrate; wherein
the first winding has a first end and a second end, the first end of the first winding is electrically connected to the first power device chip, and the second end of the first winding is electrically connected to a first output voltage terminal; and wherein
the second winding has a first end and a second end, the first end of the second winding is electrically connected to a second output voltage terminal, and the second end of the second winding is electrically connected the second power device chip.

2. The power module of claim 1, wherein:
the first portions of each of the first winding and the second winding extend along the second surface of the inductor assembly;
the second portions of each of the first winding and the second winding extend along the first surface of the inductor assembly; and wherein
the fourth portions of each of the first winding and the second winding are perpendicular to the first surface of the inductor assembly.

3. The power module of claim 1, further comprising:
a bottom substrate below the device substrate, the bottom substrate has a first surface and a second surface opposite to each other, wherein the first surface of the bottom substrate faces the device substrate, the second surface of the bottom substrate comprises an input voltage pad area having at least one pad, a first output voltage pad area having at least one pad, a second output voltage pad area having at least pad, a ground pad area having at least one pad, and a signal pad area having at least two pads; wherein
the first output voltage pad area is electrically connected to the first output voltage terminal, and the second output voltage pad area is electrically connected to the second output voltage terminal.

4. The power module of claim 3, wherein the device substrate further comprises:
a first connector electrically connecting the first end of the first winding and the first power device chip;
a second connector electrically connecting the second end of the second winding and the second power device chip;
a third connector electrically connecting the second end of the first winding and the at least one pad of the first output voltage pad area; and
a fourth connector electrically connecting the first end of the second winding and the at least one pad of the second output voltage pad area.

5. The power module of claim 3, wherein:
the device substrate further comprises a first top heat layer at least partially covering the first power device chip and a second top heat layer at least partially covering the second power device chip;
each of the first power device chip and the second power device chip comprises:
a driver;
an input pin electrically connected to the at least one pad of the input voltage pad area;
a driving pin electrically connected to at least two pads of the signal pad area;
a first switch;
a second switch; and
a switching pin electrically connected to a common node of the first switch and the second switch; wherein
the first switch has a first terminal coupled to the input pin, a second terminal coupled to the switching pin, and a control terminal configured to receive a first driving signal;
the second switch has a first terminal coupled to the switching pin, a second terminal coupled to the ground pin, and a control terminal configured to receive a second driving signal;
the first end of the first winding is electrically connected to the first top heat layer, and the first end of the second winding is electrically connected to the second top heat layer; and wherein
the driver is coupled to the driving pin to receive a switching control signal, and to provide the first driving signal and the second driving signal based on the switching control signal.

6. The power module of claim 3, wherein:
the inductor assembly is arranged on the device substrate with the second surface of the inductor assembly facing the first surface of the device substrate;
the device substrate is arranged on the bottom substrate with the second surface of the device substrate facing the first surface of the bottom substrate; and wherein
the first winding and the second winding are electrically connected to the bottom substrate via the device substrate.

7. The power module of claim 1, wherein, in a direction perpendicular to the first surface of the inductor assembly, the first portion and the second portion of the first winding are at least partially overlapped, and the first portion and the second portion of the second winding are at least partially overlapped.

8. The power module of claim 1, wherein:
the magnetic core comprises a first magnetic core portion, a second magnetic core portion and a third magnetic core portion;
the first winding is embedded in the first magnetic core portion, the second winding is embedded in the second magnetic core portion, and the third magnetic core portion is interposed between the first magnetic core portion and the second magnetic core portion, separates the first winding and the second winding; and wherein
at least two of the first magnetic core portion, the second magnetic core portion, and the third magnetic core portion comprise different materials.

9. The power module of claim 1, wherein:
the inductor assembly further comprises a secondary winding interposed between the first winding and the second winding, the secondary winding comprises a first end and a second end exposed at the second surface of the inductor assembly.

10. The power module of claim 9, wherein the magnetic core comprises a first magnetic core portion, a second magnetic core portion and a third magnetic core portion, the first winding is embedded in the first magnetic core portion, the second winding is embedded in the second magnetic core portion, and the third magnetic core portion is interposed between the first magnetic core portion and the second magnetic core portion, and passes through the secondary winding.

11. The power module of claim 9, wherein:
the power module further comprises a bottom substrate below the inductor assembly, the device substrate has a first surface and a second surface opposite to each other, wherein the first surface of the bottom substrate faces the device substrate;
the second surface of the bottom substrate further comprises a first trans-inductor pad area having at least one pad, a second trans-inductor pad area having at least one pad; and wherein
the device substrate further comprises a first trans-inductor connector electrically connecting the first end of the secondary winding and the at least one pad of the first trans-inductor pad, and a second trans-inductor connector electrically connecting the second end of the secondary winding and the at least one pad of the second trans-inductor pad.

12. The power module of claim 9, wherein:
the secondary winding further comprises a first portion, a second portion and a third portion;
the first and second portions of the secondary winding are perpendicular to the second surface of the inductor assembly;
the third portion of the secondary winding connects the first and second portions of the secondary winding.

13. The power module of claim 12, wherein:
the secondary winding further comprises a fourth portion and a fifth portion;
the fourth portion of the secondary winding is connected to the first portion of the secondary winding; and wherein
the fifth portion of the secondary winding is connected to the second portion of the secondary winding.

14. The power module of claim 12, wherein:
the first portion of the secondary winding forms the first end of the secondary winding, the second portion of the secondary winding forms the second end of the secondary winding.

15. A power module comprising:
an inductor assembly having a first surface and a second surface opposite to each other, wherein the inductor assembly comprises:
a magnetic core;
a first winding and a second winding at least partially embedded within the magnetic core, each of the first winding and the second winding has a first end exposed at the second surface of the inductor assembly and a second end exposed at the second surface of the inductor assembly;
a secondary winding interposed between the first winding and the second winding, wherein the magnetic core passes through the secondary winding, the secondary winding comprises a first end and a second end exposed at the second surface of the inductor assembly; and
a device substrate below the inductor assembly, the device substrate has a first surface and a second surface opposite to each other, and comprises a first power device chip, a second power device chip, a first trans-inductor connector and a second trans-inductor connector, wherein the first power device chip and the second power device chip are embedded in the device substrate; wherein
the first end of the first winding is electrically connected to a first output voltage terminal, and the second end of the first winding is electrically connected to the first power device chip;
the first end of the second winding is electrically connected to a second output voltage terminal, and the second end of the second winding is electrically connected to the second power device chip; and wherein
the first end of the secondary winding is electrically connected to the first trans-inductor connector, and the second end of the secondary winding is electrically connected to the second trans-inductor connector.

16. The power module of claim 15, wherein each of the first winding and the second winding comprises:
a first portion;
a second portion comprising a top surface exposed at the first surface of the inductor assembly;
a third portion connecting the first portion and the second portion, the third portion is perpendicular to the first surface and the second surface of the inductor assembly; and
a fourth portion connected to the second portion.

17. The power module of claim 16, wherein,
the first portion of each of the first winding and the second winding extends along the second surface of the inductor assembly;
the second portion of each of the first winding and the second winding extends along the first surface of the inductor assembly; and wherein
the fourth portion of each of the first winding and the second winding is perpendicular to the first surface of the inductor assembly.

18. The power module of claim 16, wherein, in a direction perpendicular to the first surface of the inductor assembly, the first portion and the second portion of the first winding are at least partially overlapped, and the first portion and the second portion of the second winding are at least partially overlapped.

19. The power module of claim 16, wherein:
the secondary winding comprises a first portion, a second portion and a third portion;
the first portion of the secondary winding is perpendicular to the second surface of the inductor assembly;
the second portion of the secondary winding is perpendicular to the second surface of the inductor assembly; and wherein
the third portion of the secondary winding connects the first portion and the second portion of the secondary winding;
the first portion of the secondary winding is adjacent to the fourth portion of the first winding, and the second portion of the secondary winding is adjacent to the third portion of the second winding.

20. The power module of claim 15, wherein the magnetic core comprises:
a first magnetic core portion, the first winding is embedded in the first magnetic core portion;
a second magnetic core portion, the second winding is embedded in the second magnetic core portion; and
a third magnetic core portion interposed between the first magnetic core portion and the second magnetic core portion, separating the first winding and the second winding; wherein
at least a portion of the third magnetic core portion passes through the secondary winding.

21. The power module of claim 15, wherein the power module further comprises:
a bottom substrate below the device substrate, the bottom substrate has a first surface and a second surface opposite to each other, wherein the first surface of the bottom substrate faces the device substrate, the second surface of the bottom substrate comprises an input voltage pad area having at least one pad, a first output voltage pad area having at least one pad, a second output voltage pad area having at least pad, a ground pad area having at least one pad, and a signal pad area having at least two pads; wherein
the first output voltage pad area is electrically connected to the first output voltage terminal, and the second output voltage pad area is electrically connected to the second output voltage terminal; and wherein
the first trans-inductor connector electrically connecting the first end of the secondary winding and the at least one pad of the first trans-inductor pad, and the second trans-inductor connector electrically connecting the second end of the secondary winding and the at least one pad of the second trans-inductor pad.

22. The power module of claim 21, wherein:
the inductor assembly is arranged on the device substrate with the second surface of the inductor assembly facing the first surface of the device substrate;
the device substrate is arranged on the bottom substrate with the second surface of the device substrate facing the first surface of the bottom substrate; and wherein
the first winding and the second winding are electrically connected to the bottom substrate via the device substrate.

23. The power module of claim 21, wherein each of the first power device chip and the second power device chip comprises:
a driving pin electrically connected to at least two pads of the signal pad area;
an input pin electrically connected to the at least one pad of the input voltage pad area,
a driver;
a first switch;
a second switch; and
a switching pin electrically connected to a common node of the first switch and the second switch; wherein
the first switch has a first terminal coupled to the input pin, a second terminal coupled to the switching pin, and a control terminal configured to receive a first driving signal;
the second switch has a first terminal coupled to the switching pin, a second terminal coupled to the ground pin, and a control terminal configured to receive a second driving signal; and wherein
the driver is coupled to the driving pin to receive a switching control signal, and to provide the first driving signal and the second driving signal based on the switching control signal.

24. The power module of claim 21, wherein the device substrate further comprises:
a first top heat layer at least partially covering the first power device chip;
a second top heat layer at least partially covering the second power device chip;
a first connector electrically connecting the second end of the first winding and the first power device chip;
a second connector electrically connecting the second end of the second winding and the second power device chip;
a third connector electrically connecting the first end of the first winding and the at least one pad of the first output voltage pad area; and
a fourth connector electrically connecting the first end of the second winding and the at least one pad of the second output voltage pad area; wherein
the first trans-inductor connector and the second trans-inductor connector are placed between the first power device chip and the second power device chip; and wherein
the first end of the first winding is electrically connected to the first top heat layer, and the first end of the second winding is electrically connected to the second top heat layer.

25. An inductor assembly for a power module, the inductor assembly comprises:
a first surface and a second surface opposite to each other;
a magnetic core;
a first winding and a second winding at least partially embedded within the magnetic core, each of the first winding and the second winding comprises:
a first portion;
a second portion comprising a top surface exposed at the first surface of the inductor assembly;
a third portion connecting the first portion and the second portion, the third portion is perpendicular to the first surface and the second surface of the inductor assembly; and
a fourth portion connected to the second portion;
a secondary winding interposed between the first winding and the second winding, and at least partially embedded within the magnetic core, the secondary winding comprises a first end and a second end exposed at the second surface of the inductor assembly; wherein
the first winding has a first end and a second end, the first end of the first winding is electrically connected to a first pad to receive a first input signal, the second end of the first winding is electrically connected to a second pad to provide a first output signal;
the second winding has a first end and a second end, the second end of the second winding is electrically connected to a third pad to receive a second input signal, the first end of the second winding is electrically connected to a fourth pad to provide a second output signal; and wherein
the first end of the secondary winding is electrically connected to a fifth pad, the second end of the secondary winding is electrically connected to a sixth pad.

26. The inductor assembly of claim 25, wherein:
the secondary winding comprises a first portion, a second portion, a third portion, a fourth portion, and a fifth portion;
the first portion of the secondary winding is perpendicular to the second surface of the inductor assembly;
the second portion of the secondary winding is perpendicular to the second surface of the inductor assembly;
the third portion of the secondary winding connects the first portion and the second portion;
the fourth portion of the secondary winding is connected to the first portion of the secondary winding;
the fifth portion of the secondary winding is connected to the second portion of the secondary winding.

27. The inductor assembly of claim 25, wherein:
the secondary winding is interposed between the first and second windings; and wherein
the magnetic core passes through the secondary winding.

28. The inductor assembly of claim 25, wherein the magnetic core comprises:
a first magnetic core portion, the first winding is embedded in the first magnetic core portion;
a second magnetic core portion, the second winding is embedded in the second magnetic core portion; and
a third magnetic core portion interposed between the first magnetic core portion and the second magnetic core portion, separating the first winding and the second winding; wherein
at least a portion of the third magnetic core portion passes through the secondary winding.

29. An inductor assembly for a power module, the inductor assembly comprising:
a first surface and a second surface opposite to each other;
a magnetic core; and
a first winding and a second winding at least partially embedded within the magnetic core, each of the first winding and the second winding comprises:
a first portion;
a second portion comprising a top surface exposed at the first surface of the inductor assembly;
a third portion connecting the first portion and the second portion, the third portion is perpendicular to the first surface and the second surface of the inductor assembly; and
a fourth portion connected to the second portion; wherein
the first winding has a first end and a second end, the first end of the first winding is electrically connected to a first pad to receive a first input signal, the second end of the first winding is electrically connected to a second pad to provide a first output signal; and wherein
the second winding has a first end and a second end, the second end of the second winding is electrically connected to a third pad to receive a second input signal, the first end of the second winding is electrically connected to a fourth pad to provide a second output signal.

30. The inductor assembly of claim 29, wherein:
the first portion of each of the first winding and the second winding extends along the second surface of the inductor assembly;
the second portion of each of the first winding and the second winding extends along the first surface of the inductor assembly; and wherein
the fourth portion of each of the first winding and the second winding is perpendicular to the first surface of the inductor assembly.

31. The inductor assembly of claim 29, wherein:
the magnetic core comprises a first magnetic core portion, a second magnetic core portion and a third magnetic core portion;
the first winding is embedded in the first magnetic core portion, the second winding is embedded in the second magnetic core portion, and the third magnetic core portion is interposed between the first magnetic core portion and the second magnetic core portion, separating the first winding from the second winding.

32. The inductor assembly of claim 29, wherein:
the inductor assembly further comprises a secondary winding, the secondary winding is interposed between the first winding and the second winding, and is at least partially embedded within the magnetic core, the secondary winding comprises a first end and a second end exposed at the second surface of the inductor assembly; and wherein
the first end of the secondary winding is electrically connected to a fifth pad, the second end of the secondary winding is electrically connected a sixth pad.

33. The inductor assembly of claim 32, wherein:
the secondary winding comprises a first portion, a second portion, a third portion, a fourth portion, and a fifth portion;
the first portion of the secondary winding is perpendicular to the second surface of the inductor assembly;
the second portion of the secondary winding is perpendicular to the second surface of the inductor assembly;
the third portion of the secondary winding connects the first portion and the second portion of the secondary winding;
the fourth portion of the secondary winding is connected to the first portion of the secondary winding;
the fifth portion of the secondary winding is connected to the second portion of the secondary winding.

34. The inductor assembly of claim 32, wherein the magnetic core comprises a first magnetic core portion, a second magnetic core portion and a third magnetic core portion, the first winding is embedded in the first magnetic core portion, the second winding is embedded in the second magnetic core portion, and the third magnetic core portion is interposed between the first magnetic core portion and the second magnetic core portion, at least a portion of the third magnetic core portion passes through the secondary winding.

35. The inductor assembly of claim 29, wherein:
the first portion of the first winding forms the first end of the first winding, the fourth portion of the first winding forms the second end of the first winding; and wherein
the first portion of the second winding forms the first end of the second winding, the fourth portion of the second winding forms the second end of the second winding.
